(19) United States
(12) Patent Application Publication
(10) Pub. No.: US 2026/0223088 A1
(43) Pub. Date: Jul. 30, 2026

(54) USER EQUIPMENT AND BASE STATION IN WIRELESS COMMUNICATION SYSTEM AND METHOD PERFORMED BY THE SAME

(71) Applicant: Samsung Electronics Co., Ltd., Suwon-si (KR)

(72) Inventors: Yuanyuan ZHANG, Beijing (CN); Sa ZHANG, Beijing (CN); He WANG, Beijing (CN); Dan LIU, Beijing (CN); Jiseon KANG, Suwon-si (KR); Bozhi LI, Beijing (CN)

(21) Appl. No.: 19/453,479

(22) Filed: Jan. 20, 2026

Related U.S. Application Data
(63) Continuation of application No. PCT/KR2026/000456, filed on Jan. 8, 2026.

(30) Foreign Application Priority Data
Jan. 26, 2025 (CN) 202510125048.3
Nov. 3, 2025 (CN) 202511596853.0

(51) Int. Cl. H04W 72/0446; H04L 1/1607; H04W 72/232

(52) U.S. Cl. CPC H04W 72/0446; H04L 1/1614; H04W 72/232

(57) ABSTRACT

A method performed by a user equipment (UE) in a wireless communication system is provided. The method includes receiving, by the UE, one or more first configuration information, wherein each of the one or more first configuration information indicates a switching pattern over a plurality of time units, wherein the plurality of time units includes a first time unit and a second time unit, receiving and/or transmitting, by the UE, on a first cell in the first time unit, and receiving and/or transmitting, by the UE, on a second cell in the second time unit.

### CROSS-REFERENCE TO RELATED APPLICATION(S)

This application is a continuation application, claiming priority under 35 U.S.C. § 365 (c), of an International application No. PCT/KR2026/000456, filed on Jan. 8, 2026, which is based on and claims the benefit of a Chinese patent application number 202510125048.3, filed on Jan. 26, 2025, in the Chinese Intellectual Property Office, and of a Chinese patent application number 202511596853.0, filed on Nov. 3, 2025, in the Chinese Intellectual Property Office, the disclosure of each of which is incorporated by reference herein in its entirety.

### BACKGROUND

### Field

The disclosure relates to a field of wireless communication technology. More particularly, the disclosure relates to a user equipment and a base station in a wireless communication system and methods performed by the same.

### Background

In order to meet the increasing demand for wireless data communication services since the deployment of 4th generation (4G) communication systems, efforts have been made to develop improved 5th generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid frequency shift keying (FSK) and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a user equipment and a base station in a wireless communication system and methods performed by the same.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes transmitting a first UE capability of the UE to a base station, wherein the first UE capability includes a switching period required for switching of the UE between at least two component carriers of carrier aggregation, and receiving first configuration information from the base station, wherein the first configuration information includes a frame pattern for the UE, wherein the frame pattern includes a type of each subframe.

According to embodiments of the disclosure, the method further includes transmitting a second UE capability of the UE to the base station, wherein the second UE capability includes a maximum number of switching supported by the UE in one time unit.

According to embodiments of the disclosure, the method further includes receiving second configuration information related to a special subframe in the frame pattern from the base station, wherein the special subframe includes symbols used for each of the at least two component carriers and a gap period, wherein the second configuration information includes one or more of numbers of symbols used for each of the at least two component carriers included in the special subframe, and information related to a component carrier corresponding to a starting symbol in the special subframe.

According to embodiments of the disclosure, the method further includes receiving third configuration information from the base station, wherein the third configuration information includes information related to a location where carrier switching occurs, wherein the location includes one or more of subframes used for each of the at least two component carriers, symbols used for each of the at least two component carriers in a special subframe, the gap period in the special subframe.

According to embodiments of the disclosure, the method further includes transmitting a third UE capability of the UE to the base station, wherein the third UE capability indicates that power boosting is supported when the UE switches between the at least two component carriers.

According to embodiments of the disclosure, the time unit is a frame.

According to embodiments of the disclosure, the frame pattern further includes a switching periodicity.

According to embodiments of the disclosure, the type of subframe includes one or more of subframes used for each of the at least two component carriers, a special subframe.

According to embodiments of the disclosure, the component carrier is one of the following, a supplementary downlink (SDL) component carrier, an FDD component carrier, and a time division duplex (TDD) component carrier.

According to embodiments of the disclosure, the method further includes performing switching between the at least two component carriers based on one or more of the first configuration information, the second configuration information and the third configuration information.

In accordance with another aspect of the disclosure, a method performed by a base station in a wireless communication system is provided. The method includes receiving a first user equipment (UE) capability of a user equipment (UE) from the UE, wherein the first UE capability includes a switching period required for switching of the UE between at least two component carriers of carrier aggregation, and transmitting first configuration information to the UE, wherein the first configuration information includes a frame pattern for the UE, wherein the frame pattern includes a type of each subframe.

According to embodiments of the disclosure, the method further includes receiving a second UE capability of the UE from the UE, wherein the second UE capability includes a maximum number of switching supported by the UE in one time unit.

According to embodiments of the disclosure, the method further includes transmitting second configuration information related to a special subframe in the frame pattern to the UE, wherein the special subframe includes symbols used for each of the at least two component carriers and a gap period, wherein the second configuration information includes one or more of numbers of symbols used for each of the at least two component carriers included in the special subframe, and information related to a component carrier corresponding to a starting symbol in the special subframe.

According to embodiments of the disclosure, the method further includes transmitting third configuration information to the UE, wherein the third configuration information includes information related to a location where carrier switching occurs, wherein the location includes one or more of subframes used for each of the at least two component carriers, symbols used for each of the at least two component carriers in a special subframe, the gap period in the special subframe.

According to embodiments of the disclosure, the method further includes receiving a third UE capability of the UE from the UE, wherein the third UE capability indicates that power boosting is supported when the UE switches between the at least two component carriers.

According to embodiments of the disclosure, the time unit is a frame.

According to embodiments of the disclosure, the frame pattern further includes a switching periodicity.

According to embodiments of the disclosure, the type of subframe includes one or more of subframes used for each of the at least two component carriers, a special subframe.

According to embodiments of the disclosure, the component carrier is one of the following, a supplementary downlink (SDL) component carrier, an FDD component carrier, and a time division duplex (TDD) component carrier.

According to embodiments of the disclosure, one or more of the first configuration information, the second configuration information and the third configuration information are used to perform switching between the at least two component carriers.

In accordance with another aspect of the disclosure, a method performed by a user equipment (UE) in a wireless communication system is provided. The method includes receiving, by the UE, one or more first configuration information, wherein each of the one or more first configuration information indicates a switching pattern over a plurality of time units, wherein the plurality of time units includes a first time unit and a second time unit, receiving and/or transmitting, by the UE, on a first cell in the first time unit, and receiving and/or transmitting, by the UE, on a second cell in the second time unit.

According to embodiments of the disclosure, the first configuration information includes a bitmap, wherein a length of the bitmap corresponds to a total number of the plurality of time units, wherein a bit in the bitmap corresponding to the first time unit has a first value and a bit in the bitmap corresponding to the second time unit has a second value that is different from the first value.

According to embodiments of the disclosure, the method further includes transmitting first UE capability information, wherein the first UE capability information includes a switching period between the first cell and the second cell.

According to embodiments of the disclosure, the method further includes not receiving and/or transmitting during the switching period.

According to embodiments of the disclosure, the method further includes receiving a first downlink control information (DCI) format, wherein the first DCI format indicates that a first switching pattern indicated by one of the one or more first configuration information is activated, and applying the first switching pattern after a first time after receiving the first DCI format, wherein in a first time unit after the first time, the UE receives and/or transmits only on the first cell, and in a second time unit after the first time, the UE receives and/or transmits only on the second cell.

According to embodiments of the disclosure, the method further includes receiving a second downlink control information (DCI) format, wherein the second DCI format indicates that a second switching pattern indicated by one of the one or more first configuration information is deactivated.

According to embodiments of the disclosure, the method further includes receiving and/or transmitting only on the first cell after a second time after receiving the second DCI format.

According to embodiments of the disclosure, the method further includes receiving first indication information, wherein the first indication information indicates that the UE receives and/or transmits only on the second cell after the second switching pattern is deactivated.

According to embodiments of the disclosure, the method further includes receiving and/or transmitting only on the second cell after a second time after receiving the second DCI format.

According to embodiments of the disclosure, the method further includes receiving a third downlink control information (DCI) format, wherein the third DCI format indicates receiving and/or transmitting on the first cell in the second time unit, and receiving and/or transmitting on the first cell in the second time unit after receiving the third DCI format.

According to embodiments of the disclosure, the method further includes receiving a fourth downlink control information (DCI) format, wherein the fourth DCI format indicates receiving and/or transmitting on the second cell in the first time unit, and receiving and/or transmitting on the second cell in the first time unit after receiving the fourth DCI format.

According to embodiments of the disclosure, the method further includes receiving second configuration information, wherein the second configuration information indicates a switching pattern among the first cell, the second cell, and a gap period in a special time unit among the plurality of time units, and receiving and/or transmitting on the first cell and the second cell in a time division multiplexing (TDM) manner based on the switching pattern in the special time unit, wherein the special time unit is a time unit including time resources for the first cell, time resources for the second cell, and time resources for the gap period.

In accordance with another aspect of the disclosure, a method performed by a base station (BS) in a wireless communication system is provided. The method includes transmitting, by the BS, one or more first configuration information, wherein each of the one or more first configuration information indicates a switching pattern over a plurality of time units, wherein the plurality of time units includes a first time unit and a second time unit, receiving and/or transmitting, by the BS, only on a first cell in the first time unit, and receiving and/or transmitting, by the BS, only on a second cell in the second time unit.

According to embodiments of the disclosure, the first configuration information includes a bitmap, wherein a length of the bitmap corresponds to a total number of the plurality of time units, wherein a bit in the bitmap corresponding to the first time unit has a first value and a bit in the bitmap corresponding to the second time unit has a second value that is different from the first value.

According to embodiments of the disclosure, the method further includes receiving first UE capability information, wherein the first UE capability information includes a switching period between the first cell and the second cell.

According to embodiments of the disclosure, the method further includes not receiving and/or transmitting during the switching period.

According to embodiments of the disclosure, the method further includes transmitting a first downlink control information (DCI) format, wherein the first DCI format indicates that a first switching pattern indicated by one of the one or more first configuration information is activated, wherein the first switching pattern is applied after a first time after a user equipment (UE) receives the first DCI format, and wherein in a first time unit after the first time, the UE receives and/or transmits only on the first cell, and in a second time unit after the first time, the UE receives and/or transmits only on the second cell.

According to embodiments of the disclosure, the method further includes transmitting a second downlink control information (DCI) format, wherein the second DCI format indicates that a second switching pattern indicated by one of the one or more first configuration information is deactivated.

According to embodiments of the disclosure, the method further includes receiving and/or transmitting only on the first cell after a second time after transmitting the second DCI format.

According to embodiments of the disclosure, the method further includes transmitting first indication information, wherein the first indication information indicates that the UE receives and/or transmits only on the second cell after the second switching pattern is deactivated.

According to embodiments of the disclosure, the method further includes receiving and/or transmitting only on the second cell after a second time after transmitting the second DCI format.

According to embodiments of the disclosure, the method further includes transmitting a third downlink control information (DCI) format, wherein the third DCI format indicates receiving and/or transmitting on the first cell in the second time unit, and receiving and/or transmitting on the first cell in the second time unit after transmitting the third DCI format.

According to embodiments of the disclosure, the method further includes transmitting a fourth downlink control information (DCI) format, wherein the fourth DCI format indicates receiving and/or transmitting on the second cell in the first time unit, and receiving and/or transmitting on the second cell in the first time unit after transmitting the fourth DCI format.

According to embodiments of the disclosure, the method further includes transmitting second configuration information, wherein the second configuration information indicates a switching pattern among the first cell, the second cell, and a gap period in a special time unit among the plurality of time units, and receiving and/or transmitting on the first cell and the second cell in a time division multiplexing (TDM) manner based on the switching pattern in the special time unit, wherein the special time unit is a time unit including time resources for the first cell, time resources for the second cell, and time resources for the gap period.

In accordance with another aspect of the disclosure, a user equipment (UE) in a wireless communication system is provided. The UE includes a transceiver configured to transmit and receive signals, memory, comprising one or more storage media, storing instructions, and a controller including one or more processors coupled to the transceiver and the memory. The instructions, when executed by the one or more processors individually or collectively, cause the UE to receive one or more first configuration information, wherein each of the one or more first configuration information indicates a switching pattern over a plurality of time units including a first time unit and a second time unit, receive and/or transmit on a first cell in the first time unit, and receive and/or transmit on a second cell in the second time unit.

In accordance with another aspect of the disclosure a base station in a wireless communication system is provided. The base station includes a transceiver configured to transmit and receive signals, memory, comprising one or more storage media, storing instructions, and a controller including one or more processors coupled to the transceiver and memory. The instructions, when executed by the one or more processors individually or collectively, cause the base station to transmit one or more first configuration information, wherein each of the one or more first configuration information indicates a switching pattern over a plurality of time units, and wherein the plurality of time units includes a first time unit and a second time unit, receive and/or transmit on a first cell in the first time unit, and receive and/or transmit on a second cell in the second time unit.

In accordance with another aspect of the disclosure, one or more non-transitory computer-readable storage media storage media storing one or more computer programs including computer-executable instructions that, when executed by one or more processors of a user equipment (UE) individually or collectively, cause the UE to perform operations are provided. The operations include receiving, by the UE, one or more first configuration information, wherein each of the one or more first configuration information indicates a switching pattern over a plurality of time units, wherein the plurality of time units includes a first time unit and a second time unit, receiving and/or transmitting, by the UE, on a first cell in the first time unit, and receiving and/or transmitting, by the UE, on a second cell in the second time unit.

In accordance with another aspect of the disclosure, one or more non-transitory computer-readable storage media storing one or more computer programs including computer-executable instructions that, when executed by one or more processors of a base station (BS) individually or collectively, cause the BS to perform operations are provided. The operations include transmit one or more first configuration information, wherein each of the one or more first configuration information indicates a switching pattern over a plurality of time units, and wherein the plurality of time units includes a first time unit and a second time unit, receive and/or transmit on a first cell in the first time unit, and receive and/or transmit on a second cell in the second time unit.

The methods performed by the user equipment (UE) and/or the base station in the wireless communication system provided by the disclosure, by exchanging capability information of the UE and/or configuration information of the base station between the UE and the base station, can effectively support switching between different component carriers in carrier aggregation and full utilization of different component carriers in carrier aggregation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIGS. 2A and 2B illustrate example wireless transmission and reception paths according to various embodiments of the disclosure;

FIG. 3A illustrates an example UE according to an embodiment of the disclosure;

FIG. 3B illustrates an example gNB according to an embodiment of the disclosure;

FIG. 4 illustrates a schematic diagram of an operation of an FDD+SDL CA according to an embodiment of the disclosure;

FIG. 5A illustrates an example in which a UE receives and/or transmits on different cells in different time units according to received first configuration information according to an embodiment of the disclosure;

FIG. 5B illustrates an example of a switching pattern according to an embodiment of the disclosure;

FIG. 5C illustrates an example of a configuration of a special slot according to an embodiment of the disclosure;

FIG. 5D illustrates an example of a switching gap according to an embodiment of the disclosure;

FIG. 5E illustrates an example in which a UE receives and/or transmits on different cells in different time units according to received first configuration information and third configuration information according to an embodiment of the disclosure;

FIG. 5F illustrates examples of different switching gap locations according to an embodiment of the disclosure;

FIG. 5G illustrates examples of switching periods according to an embodiment of the disclosure;

FIG. 5H illustrates an example in which a UE receives DCI for activating a switching pattern according to an embodiment of the disclosure;

FIG. 5I illustrates an example in which a UE receives DCI for deactivating a switching pattern according to an embodiment of the disclosure;

FIG. 5J illustrates an example timing diagram of activation and deactivation of switching patterns according to an embodiment of the disclosure;

FIG. 5K illustrates an example in which a UE receives first indication information according to an embodiment of the disclosure;

FIGS. 5L, 5M, and 5N illustrate examples of changing applied switching patterns through DCI according to various embodiments of the disclosure;

FIG. 5O illustrates a schematic diagram of exchanging of UE capability and configuration information between a UE and a NW according to an embodiment of the disclosure;

FIG. 6A illustrates a flowchart of a method performed by a user equipment (UE) in a wireless communication system according to an embodiment of the disclosure;

FIG. 6B illustrates a flowchart of a method performed by a user equipment (UE) in a wireless communication system according to an embodiment of the disclosure;

FIG. 7A illustrates a flowchart of a method performed by a base station in a wireless communication system according to an embodiment of the disclosure;

FIG. 7B illustrates a flowchart of a method performed by a base station in a wireless communication system according to an embodiment of the disclosure;

FIG. 8 illustrates a schematic diagram of a user equipment (UE) in a wireless communication system according to an embodiment of the disclosure; and

FIG. 9 illustrates a schematic diagram of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The various embodiments of the disclosure can be applied to various communication systems, such as: global system for mobile communications (GSM) system, code division multiple access (CDMA) system, broadband code division multiple access (WCDMA) system, general packet radio service (GPRS), long term evolution (LTE) system Frequency division duplex (FDD) systems, time division duplex (TDD) systems, universal mobile telecommunications systems (UMTS), global interoperability for microwave access (WiMAX) communication systems, fifth generation (5G) systems or new wireless (NR) systems, etc. In addition, the various embodiments of the disclosure can be applied to future oriented communication technologies.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

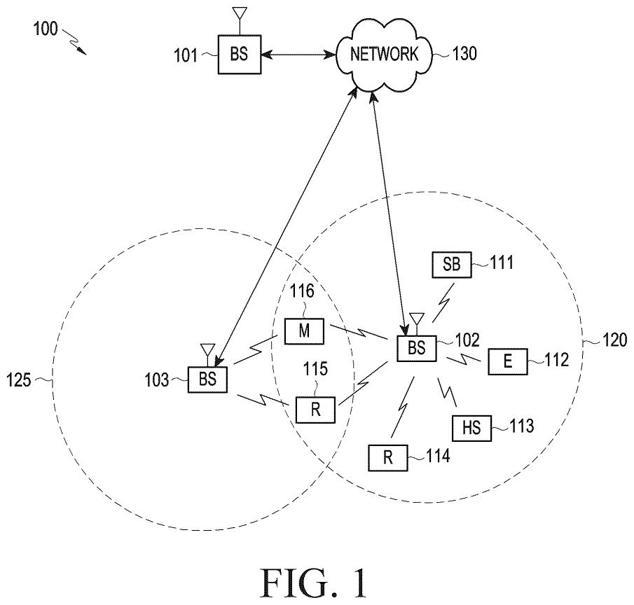

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

Referring to FIG. 1, the wireless network 100 may include a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UEs) within a coverage area 120 of the gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of the gNB 103. The second plurality of UEs include a UE 115 and a UE 116. In various embodiments, one or more of the gNBs 101-103 may communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of the disclosure. In various embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 may include any number of gNBs and any number of UEs in any suitable arrangement, for example. Furthermore, the gNB 101 may directly communicate with any number of UEs and provide wireless broadband access to the network 130 for those UEs. Similarly, each of the gNBs 102-103 may directly communicate with the network 130 and provide direct wireless broadband access to the network 130 for the UEs. In addition, the gNBs 101, 102 and/or 103 may provide access to other or additional external networks, such as external telephone networks or other types of data networks.

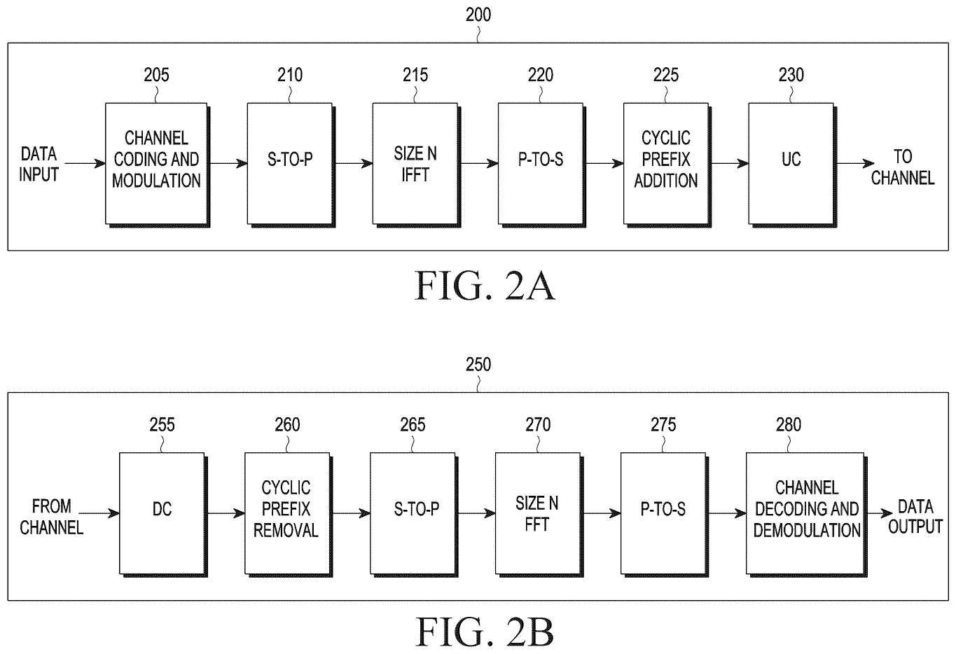

FIGS. 2A and 2B illustrate example wireless transmission and reception paths according to various embodiments of the disclosure.

Referring to FIGS. 2A and 2B, the transmission path 200 can be described as being implemented in a gNB, such as the gNB 102, and the reception path 250 can be described as being implemented in a UE, such as the UE 116. However, it should be understood that the reception path 250 can be implemented in a gNB and the transmission path 200 can be implemented in a UE. In various embodiments, the reception path 250 is configured to support codebook designs and structures for systems with 2D antenna arrays as described in embodiments of the disclosure.

The transmission path 200 may include a channel coding and modulation block 205, a serial-to-parallel (S-to-P) block 210, a size N inverse fast fourier transform (IFFT) block 215, a parallel-to-serial (P-to-S) block 220, a cyclic prefix addition block 225, and an up-converter (UC) 230. The reception path 250 may include a down-converter (DC) 255, a cyclic prefix removal block 260, a S-to-P block 265, a size N fast fourier transform (FFT) block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The S-to-P block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial (P-to-S) block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from the UEs 111-116 in the uplink. Similarly, each of the UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and the IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete fourier transform (DFT) and inverse discrete fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

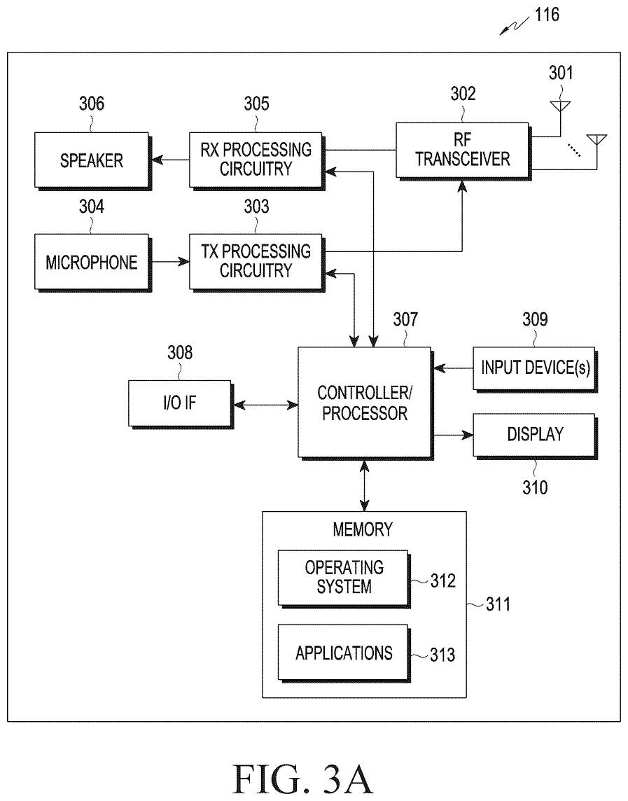

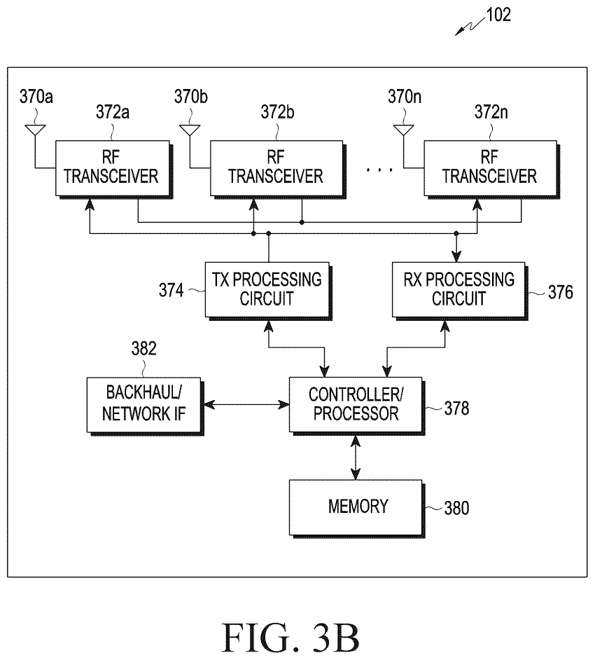

FIG. 3A illustrates an example a UE according to an embodiment of the disclosure. The embodiment of the UE 116 shown in FIG. 3A is for illustration only, and the UEs 111-115 of FIG. 1 may have the same or similar configuration. However, a UE has various configurations, and FIG. 3A does not limit the scope of the disclosure to any specific implementation of the UE.

Referring to FIG. 3A, the UE 116 may include an antenna 301, a radio frequency (RF) transceiver 302, a transmission (TX) processing circuit 303, a microphone 304, and a reception (RX) processing circuit 305. UE 116 may also include a speaker 306, a controller/processor (e.g., including processing circuitry) 307, an input/output (I/O) interface 308, an input device(s) 309, a display 310, and memory 311. The memory 311 may include an operating system (OS) 312 and one or more applications 313.

The RF transceiver 302 may receive an incoming RF signal transmitted by a gNB of the wireless network 100 from the antenna 301. The RF transceiver 302 may down-convert the incoming RF signal to generate an intermediate frequency (IF) or baseband signal. The IF or baseband signal may be transmitted to the RX processing circuit 305, where the RX processing circuit 305 generates a processed baseband signal by filtering, decoding and/or digitizing the baseband or IF signal. The RX processing circuit 305 may transmit the processed baseband signal to speaker 306 (such as for voice data) or to controller/processor 307 for further processing (such as for web browsing data).

The TX processing circuit 303 may receive analog or digital voice data from microphone 304 or other outgoing baseband data (such as network data, email or interactive video game data) from controller/processor 307. The TX processing circuit 303 may encode, multiplexes, and/or digitize the outgoing baseband data to generate a processed baseband or IF signal. The RF transceiver 302 may receive the outgoing processed baseband or IF signal from the TX processing circuit 303 may up-convert the baseband or IF signal into an RF signal transmitted via the antenna 301.

The controller/processor 307 may include one or more processors or other processing devices and execute an OS 312 stored in the memory 311 in order to control the overall operation of UE 116. For example, the controller/processor 307 may control the reception of forward channel signals and the transmission of backward channel signals through the RF transceiver 302, the RX processing circuit 305 and the TX processing circuit 303 according to well-known principles. In various embodiments, the controller/processor 307 may include at least one microprocessor or microcontroller.

The controller/processor 307 may be also capable of executing other processes and programs residing in the memory 311, such as operations for channel quality measurement and reporting for systems with 2D antenna arrays as described in embodiments of the disclosure. The controller/processor 307 may move data into or out of the memory 311 as required by an execution process. In various embodiments, the controller/processor 307 may be configured to execute the application 313 based on the OS 312 or in response to signals received from the gNB or the operator. The controller/processor 307 may be also coupled to an I/O interface 308, where the I/O interface 308 may provide the UE 116 with the ability to connect to other devices such as laptop computers and handheld computers. I/O interface 308 may be a communication path between these accessories and the controller/processor 307. The controller/processor 307 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller/processor 307 may be also coupled to the input device(s) 309 and the display 310. An operator of the UE 116 may input data into the UE 116 using the input device(s) 309. The display 310 may be a liquid crystal display or other display capable of presenting text and/or at least limited graphics (such as from a website). The memory 311 may be coupled to the controller/processor 307. A part of the memory 311 may include random access memory (RAM), while another part of the memory 311 may include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the controller/processor 307 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates an example the gNB 102 according to an embodiment of the disclosure. The embodiment of the gNB 102 shown in FIG. 3B is for illustration only, and other gNBs of FIG. 1 may have the same or similar configuration. However, a gNB has various configurations, and FIG. 3B does not limit the scope of the disclosure to any specific implementation of a gNB. It should be noted that the gNB 101 and the gNB 103 may include the same or similar structures as the gNB 102.

Referring to FIG. 3B, the gNB 102 may include a plurality of antennas 370a, 370b-370n, a plurality of RF transceivers 372a-372n, a transmission (TX) processing circuit 374, and a reception (RX) processing circuit 376. In certain embodiments, one or more of the plurality of antennas 370a-370n include a 2D antenna array, the gNB 102 may also include a controller/processor (e.g., including processing circuitry) 378, memory 380, and a backhaul or a network interface 382.

RF transceivers 372a, 372b-372n may receive an incoming RF signal from antennas 370a-370n, such as a signal transmitted by UEs or other gNBs. RF transceivers 372a-372n may down-convert the incoming RF signal to generate an IF or baseband signal. The IF or baseband signal may be transmitted to the RX processing circuit 376, where the RX processing circuit 376 may generate a processed baseband signal by filtering, decoding and/or digitizing the baseband or IF signal. RX processing circuit 376 may transmit the processed baseband signal to controller/processor 378 for further processing.

The TX processing circuit 374 may receive analog or digital data (such as voice data, network data, email or interactive video game data) from the controller/processor 378. TX processing circuit 374 may encode, multiplexe and/or digitize outgoing baseband data to generate a processed baseband or IF signal. RF transceivers 372a-372n may receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of the gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a blind interference sensing (BIS) process such as that performed through a BIS algorithm, and decode a received signal from which an interference signal is subtracted. A controller/processor 378 may support any of a variety of other functions in the gNB 102. In various embodiments, the controller/processor 378 may include at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the disclosure. In various embodiments, the controller/processor 378 supports communication between entities such as web RTCs. The controller/processor 378 may move data into or out of the memory 380 as required by an execution process. The controller/processor 378 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller/processor 378 may be also coupled to the backhaul or network interface 382. The backhaul or network interface 382 may allow the gNB 102 to communicate with other devices or systems through a backhaul connection or through a network. The backhaul or network interface 382 may support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 may allow the gNB 102 to communicate with other gNBs through wired or wireless backhaul connections. When the gNB 102 is implemented as an access point, the backhaul or network interface 382 may allow the gNB 102 to communicate with a larger network, such as the Internet, through a wired or wireless local area network or through a wired or wireless connection. The backhaul or the network interface 382 may include any suitable structure that supports communication through a wired or wireless connection, such as an Ethernet or an RF transceiver.

The memory 380 may be coupled to the controller/processor 378. A part of the memory 380 may include an RAM, while another part of the memory 380 may include a flash memory or other ROMs. In certain embodiments, a plurality of instructions, such as the BIS algorithm, are stored in the memory. The plurality of instructions may be configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a-372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 may include any number of each component shown in FIG. 3A. As a specific example, the access point may include many backhaul or network interfaces 382, and the controller/processor 378 may support routing functions to route data between different network addresses. As another specific example, although shown as including a single instance of the TX processing circuit 374 and a single instance of the RX processing circuit 376, the gNB 102 may include multiple instances of each (such as one for each RF transceiver).

Various embodiments of the disclosure are further described below in conjunction with the accompanying drawings.

The text and drawings are provided as examples only to help readers understand the disclosure. They are not intended and should not be interpreted as limiting the scope of the present in any way. Although certain embodiments and examples have been provided, based on the content disclosed herein, it is obvious to those skilled in the art that modifications to the illustrated embodiments and examples can be made without departing from the scope of the disclosure.

A switching pattern may also be referred to as a frame pattern.

Receiving and/or transmitting may refer to the reception and/or transmission of any uplink data or control signal (e.g., PUSCH, PUCCH, etc.) and/or any downlink data or control signal (e.g., PDSCH, PDCCH, etc.).

A network (NW) or a base station (BS) configuring or transmitting configuration information or downlink signals to a UE may be equivalent to the UE receiving configuration information and/or downlink signals from the NW or BS.

Low band (e.g., <1 GHz band, FDD or SDL) is a relatively scarce resource as a coverage band, and it is a challenge to fully and efficiently utilize the low band spectrum. For example, certain users may reside on an urban low band approximately 15% of the time of a day and on a rural low band approximately 50% of the time of a day. If the low band is blocked, it will greatly affect user experience. low-band carrier+low-band carrier carrier aggregation (CA) is a way to improve throughput and thus improve user experience.

Implementation of a low-band carrier+low-band carrier CA (e.g., a duplex mode of FDD+FDD, or FDD+SDL, etc.) is difficult, especially when the two bands are relatively close in frequency. Because the UE side needs a radio frequency analog triplexer/quadplexer to implement a low-band carrier+low-band carrier CA, but it is difficult to manufacture a triplexer/quadplexer with good performance or even it is impossible to implement a duplexer in the case that the frequencies are relatively close (e.g., a n12-n29 case as described below, where the n29 band falls between the uplink (UL) and the downlink (DL) of the n12 band, and the distance from the UL/DL of the n12 band is only 1 MHz). Therefore, low band-low band CA (two bands operating simultaneously) schemes are difficult to implement.

In summary, supplementary downlink (SDL) bands are basically impossible to be actually deployed in rural and suburban areas. Because SDL has only DL and no UL, and a typical band for SDL is the n29 band (held by many operators) among the low bands.

SDL cannot work independently and must be used together with another band through CA. In scenarios with high coverage requirements such as suburban and rural areas, operators need to use SDL together with another low band, that is, implement an SDL (low band)+FDD (low band) CA. However, as mentioned above, the low band-low band CA cannot be actually implemented due to the difficulty in designing radio frequency triplexers/quadplexers on the UE side. This results in that the SDL spectrum cannot be used at all, especially in suburban/rural areas, and the precious low band spectrums are completely wasted.

However, if it is an FDD+FDD low band-low band CA case, although the CA is difficult to implement, at least a single band operation may also be used. However, it is completely different for SDL, because there is no paired UL (interaction with the network (NW) cannot be performed), SDL cannot be used independently.

In order to solve the above problems, the disclosure proposes a “FDD (low)+SDL (low) CA via switching” method, which can actually make use of SDL. The component carriers (CC) of the FDD low band and the SDL low band are both connected to the NW, and the FDD band and the SDL band are used alternately via switching. That is, the cell of the FDD band and the cell of the SDL band will not operate simultaneously, so in terms of hardware implementation, the radio frequency triplexer/quadplexer will no longer be needed on the UE side.

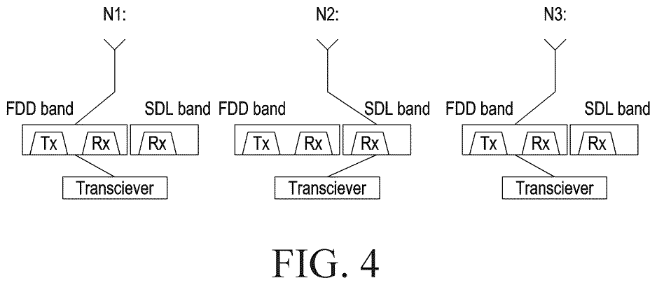

FIG. 4 illustrates a schematic diagram of the operation of an FDD+SDL CA according to an embodiment of the disclosure.

Referring to FIG. 4, for example, when there are two carriers in CA, Carrier 1 is FDD, Carrier 2 is SDL, and the two carriers correspond to two cells respectively:
at time N1, UL/DL (Tx/Rx) of FDD (Carrier 1) operates, and SDL does not operate;
at time N2, DL (Rx) of SDL (Carrier 2) operates, and FDD does not operate;
at time N3, it switches back to case where UL/DL (Tx/Rx) of FDD (Carrier 1) operates.

In summary, FDD carrier and SDL carrier will not operate simultaneously, but may be switched quickly. Moreover, because the SDL band has only DL and no UL, it cannot transmit ACK/NACK and other information to the network, so it has to switch back to the carrier in the FDD band at intervals and use the UL of FDD to interact with the NW.

It should be noted that the disclosure takes a two-carrier CA scenario of FDD carrier+SDL carrier as an example for schematic explanation. It should be understood that, herein, Carrier 1 (or referred to as a first component carrier) may be one or more of an SDL carrier, an FDD carrier, a time division duplex (TDD) carrier, or any other existing or future carrier, etc. Carrier 2 (or referred to as a second component carrier) may be one or more of an SDL carrier, an FDD carrier, a TDD carrier, or any other existing or future carrier, etc., which is not limited herein. A cell using Carrier 1 may be referred to as a first cell, and a cell using Carrier 2 may be referred to as a second cell. More generally, cell and carrier may be used interchangeably herein. In addition, the carrier aggregation via switching (CA via switching) according to embodiments of the disclosure may include at least two component carriers, and a two-component carrier case are merely used as an example for schematic explanation below.

In addition, one or more component carriers in carrier aggregation via switching (CA via switching) according to embodiments of the disclosure may also be component carriers of any band (e.g., mid-band, high-band, etc.) except the low band.

Through the methods of carrier aggregation via switching (CA via switching) proposed by the disclosure, carrier switching may be performed faster (e.g., fast switching from one carrier to another carrier), and better performance may be achieved than when multiple carriers work simultaneously, for example, higher uplink transmitting power, etc. Therefore, the methods of the disclosure also have important significance and are equally applicable to other different carrier aggregation types (such as TDD+SDL, FDD+FDD, TDD+TDD, FDD+TDD, etc.).

The disclosure, by defining new switching configuration patterns, new UE capabilities and new network radio resource control signaling (NW RRC signaling) in order for the network to configure carrier aggregation via switching (CA via switching), enables actual deployment of SDL, or faster switching between carriers, or better single carrier performance.

Embodiments of the disclosure may include the following aspects:
1.1 New switching pattern, which may be semi-statically configured by the network;
1.2 New UE capability: UE capability_1, “FDD-SDL switching period”, which may be used to report that the UE supports a CA via switching function, and may be used to report the maximum time required for the UE to complete the switching.
1.3 New UE capability: UE capability_2, “FDD-SDL Number of switching points”, which may be used to report the number of switching points (or may be referred to as the (maximum) number of switching) supported by the UE in a time unit (e.g., a frame, etc.).
1.4 New RRC signaling: RRC signaling_1, “FDD-SDL switching configuration” (“FDD-SDL switching configuration”), which may be used for the NW to configure the UE with a pattern of each frame; further, the NW also needs to configure a special subframe S, which may be configured through RRC signaling_2 “S FDD-SDL pattern”.
1.5 New RRC signaling: RRC signaling_3, “SwitchingCarrier”, which may be used for the NW to configure the UE whether switching occurs on an FDD subframe, an SDL subframe, or a special subframe.
1.6 New UE capability: UE capability_3, “Swiching-Powerboosting”, which may be used to indicate that in case that a single FDD band has a higher power class than the FDD+SDL_CA, when the UE operates in an FDD+SDL_CA via switching mode and switches to FDD, the UE may be allowed to report a higher power class capability so that the network may further boost the power of the UE.
1.7 New downlink control information (DCI) format: for example, activating DCI, which may be used to indicate to the UE that at least one of the one or more configured switching patterns is activated. The activating DCI may also be referred to as a first DCI format.
1.8 New DCI format: for example, deactivating DCI, which may be used to indicate to the UE that at least one of the one or more configured switching patterns is deactivated. The deactivating DCI may also be referred to as a second DCI format.
1.9 New indication information: for example, FallbacktoScell, which may be used to indicate that the UE receives and/or transmits on a second cell (e.g., Scell in CA, or any other cell in CA) after a switching pattern is deactivated. The indication information may also be referred to as first indication information.
1.10 New DCI format: for example, a third DCI format, which may be used to indicate to the UE to receive and/or transmit on a first cell in a second time unit. For example, in the case where the UE should receive and/or transmit on a second cell in the second time unit according to an applied or activated switching pattern, after the UE receives the third DCI format from the BS, it may receive and/or transmit on the first cell in the second time unit.
1.11 New DCI format: for example, a fourth DCI format, which may be used to indicate to the UE to receive and/or transmit on a second cell in a first time unit. For example, in the case where the UE should receive and/or transmit on a first cell in the first time unit according to an applied or activated switching pattern, after the UE receives the fourth DCI format from the BS, it may receive and/or transmit on the second cell in the first time unit.

In the disclosure, RRC signaling may be semi-static, or dynamically configured, which is not limited herein. More specific descriptions will be made below with respect to the above aspects.

### 2.1 New Patterns

1) Existing long term evolution (LTE) and new radio (NR) frame structures may still be adopted, in which, one frame is 10 ms, one frame=2 half frames=10 subframes, each half frame is 5 ms, and each subframe is 1 ms. 1 subframe may include 2 slots. Each subframe may be configured as an FDD subframe, an SDL subframe or a special subframe S and other types. Hereinafter, the description of the embodiments of the disclosure are performed using a subframe as an example of a time unit. In the following, subframe may also be replaced by any other time unit such as slot and symbol, etc.

An SDL subframe means that this subframe is used for an SDL cell (or carrier), or is referred to as a subframe for an SDL carrier/SDL cell.

An FDD subframe means that this subframe is used for an FDD cell (or carrier), or is referred to as a subframe for an FDD carrier/FDD cell. S represents a special subframe. A special subframe may include at least one of an SDL symbol, an FDD symbol and a gap period (GP). In an example, one subframe may include a total of 14 symbols. Alternatively, S may be all SDL symbols or all FDD symbols (e.g., no GP). More generally, in the case where there are at least two component carriers, the special subframe S may include symbols corresponding to each of the at least two component carriers, and a gap period. Similarly, an SDL symbol means that this symbol is used for an SDL cell (or carrier), or is referred to as a symbol for an SDL carrier/SDL cell; and an FDD symbol means that this symbol is used for an FDD cell (or carrier), or is referred to as a subframe for an FDD carrier/FDD cell.

2) A switching periodicity of a pattern may be 5 ms or 10 ms, or any other value. It should be noted that the switching periodicity is not the switching period/switching duration between SDL and FDD as described above or below, but a parameter in the pattern configuration, which may represent the repetition period of subframes within a pattern. For example, if the switching periodicity of a pattern is 5 ms, it may mean that subframes 0-4 and subframes 5-9 in the pattern are exactly the same, as shown in pattern 0/1/2 in Table 1 below.

3) After configuring the frame pattern, the special subframe S in the frame needs to be further configured by the network, which will be described in more detail in Section 2.4 below.

4) The pattern may change from frame to frame (e.g. every 10 ms the pattern may be the same or different).

Table 1 shows several example patterns according to embodiments of the disclosure.

TABLE 1

| | Switching | Subframe Number | | | | | | | | | |
|---|---|---|---|---|---|---|---|---|---|---|---|
| Pattern | Periodicity | 0 | 1 | 2 | 3 | 4 | 5 | 6 | 7 | 8 | 9 |
| 0 | 5 ms | SDL | S | FDD | FDD | FDD | SDL | S | FDD | FDD | FDD |
| 1 | 5 ms | SDL | S | FDD | FDD | SDL | SDL | S | FDD | FDD | SDL |
| 2 | 5 ms | SDL | S | FDD | SDL | SDL | SDL | S | FDD | SDL | SDL |
| 3 | 10 ms | SDL | S | FDD | FDD | FDD | SDL | SDL | SDL | SDL | SDL |
| 4 | 10 ms | SDL | S | FDD | FDD | SDL | SDL | SDL | SDL | SDL | SDL |
| 5 | 10 ms | SDL | S | FDD | SDL | SDL | SDL | SDL | SDL | SDL | SDL |
| 6 | 10 ms | SDL | S | FDD | FDD | FDD | SDL | SDL | FDD | FDD | SDL |

As shown in Table 1 above, pattern 0 means that subframes 0-9 in the frame are: SDL, S, FDD, FDD, FDD, SDL, S, FDD, FDD, FDD, and the switching periodicity is 5 ms. Pattern 1 means that subframes 0-9 in this frame are: SDL, S, FDD, FDD, SDL, SDL, S, FDD, FDD, SDL, and the switching periodicity is 5 ms. Pattern 5 means that subframes 0-9 in the frame are: SDL, S, FDD, FDD, FDD, SDL, SDL, FDD, FDD, FDD, and the switching periodicity is 10 ms, and so on.

The above switching periodicity may also be referred to as switching cycle, conversion periodicity, etc., and the switching periodicity is related to the repetition of the upper half frame and the lower half frame in a frame. When the upper half frame and the lower half frame are repetitive, the switching periodicity may be N1. When the upper half frame and the lower half frame are not repetitive, the switching periodicity may be N2, where N2=2N1, N1 may be 5 ms, and N2 may be 10 ms.

It should be understood that each frame pattern shown in Table 1 above is only an example, and frame patters according to the embodiments of the disclosure may further include any other suitable subframe arrangement, which is not limited herein.

Typically, switching occurs at the intersection of SDL symbols and FDD symbols, and specifically whether it occurs on an SDL frame, on an FDD frame, on an SDL symbol in an S frame, on an FDD symbol in an S frame, or on a gap period (GP) in an S frame may be further configured or indicated by the network, as will be described in more detail in Section 2.5 below.

It should be understood that although the example pattern shown in Table 1 is exemplarily described with two carriers, FDD and SDL, according to embodiments of the disclosure, the FDD subframe (or FDD symbol) in the example pattern shown in Table 1 may also be replaced by a subframe or symbol of any other existing (such as TDD/SDL subframe or symbol) or future carrier, and the SDL subframe (or SDL symbol) may also be replaced by an FDD subframe (or FDD symbol), or TDD subframe (or TDD symbol) or subframe or symbol of any other existing or future carrier, which is not limited herein.

By defining a new pattern structure, the network may determine or configure frame patterns for the UE based on cell load status, deployment scenario, UE capabilities reported by the UE (such as introduced in 2.2 and 2.2), etc., thereby facilitating the UE to switch between the FDD cell and the SDL cell.

2.2 New UE capability: UE capability_1 (which may be referred to herein as a first UE capability), “FDD-SDL switching period”, which may be used to report that the UE supports a CA via switching function (that is, the UE capability may include information indicating that the UE supports a CA via switching function), and may be used to report the maximum time required for the UE to complete the switching. That is, the first UE capability may include the switching period required for the UE to switch between at least two component carriers of the carrier aggregation (e.g., between any two of the at least two component carriers). In an example, assuming that the CA may include a first cell and a second cell, the first UE capability may include a switching period of the UE between the first cell and the second cell. The UE capability may also be referred to herein as UE capability information.

Table 2 illustrates an example of the first UE capability according to embodiments of the disclosure (taking FDD+SDL two carriers as an example).

TABLE 2

| | | | |
|---|---|---|---|
| FDD-SDL switching period | BC/UE | optional | FR1 |
| It reports the time length required for carrier | | | Only |
| switching under an FDD band + SDL band CA | | | |
| supported by the UE. | | | |
| Two parameters may be further included: | | | |
| (Maximum) switching length from FDD to | | | |
| SDL | | | |
| (Maximum) switching length from SDL to | | | |
| FDD | | | |
| The above two may be the same or different, | | | |
| and nXus or nYus or nZus or nLus can be | | | |
| reported. | | | |
| nXus represents Xus, nYus represents Yus, | | | |
| nZus represents Zus, and nLus represents Lus. | | | |
| Where X, Y, Z, L may be one or more of 0 us, | | | |
| 35 us, 70 us, 140 us or any other value. | | | |

An example of the first UE capability according to embodiments of the disclosure is expressed as follows:

$$FDD - SDL switching period =$$

$$Switching length from FDD to SDL = enumerated \{ nXus , nYus , nZus , nLus \}$$

$$Switching length from SDL to FDD = enumerated \{ nXus , nYus , nZus , nLus \}$$

where enumerated {nXus, nYus, nZus, nLus} may represent selecting a value from nXus, nYus, nZus, nLus.

In addition, as shown in Table 2 above, “optional” means that the first UE capability may be an optional UE capability; “BC/UE” may mean that the first UE capability may be reported per band combination, or may be reported per UE. If reported per band combination, the UE may support different switching periods (also called switching lengths or switching durations) for different band combinations (BCs). If reported per UE, all FDD+SDL combinations support the same switching period (of course, the “(maximum) switching length from FDD to SDL” and “(maximum) switching length from SDL to FDD” may be different).

“FR1 only” means that the first UE capability only applies to frequency range 1 (FR1) and not to frequency range 2 (FR2).

If the UE capability is not reported, it may mean that the UE does not support a “CA via switching” function proposed in the disclosure, so the network cannot configure the CA of the UE to the “CA via switching” mode.

The UE may report supported maximum time length required for carrier switching (e.g., from FDD to SDL and/or from SDL to FDD) depending on its actual capabilities. After the network configures the UE to perform carrier switching, the UE needs to complete the switching within the reported time. This UE capability may be used as auxiliary information for the NW to select/configure a pattern for the UE, assisting the NW to select/configure a more suitable pattern for the UE.

2.3 New UE capability: UE capability_2 (herein, it may be referred to as the second UE capability), “FDD-SDL Number of switching points”, which may be used to report the number of switching points (or may be referred to as the number of switching) supported by the UE in a time unit (e.g., a frame, etc.). A time unit may also include one or more of a frame, a subframe, a slot, a mini-slot, a symbol, etc.

Table 3 illustrates an example of a second UE capability according to embodiments of the disclosure.

TABLE 3

| | | | |
|---|---|---|---|
| FDD-SDL Number of switching points | BC/UE | optional | FR1 |
| It reports the maximum number of switching | | | Only |
| points supported by the UE for switching | | | |
| between different carriers in a frame (which | | | |
| may be less than or equal to 5 (or any other | | | |
| value)). | | | |
| The prerequisite for reporting this UE | | | |
| capability is that the UE also reports the | | | |
| “FDD-SDL switching period”. | | | |
| If this UE capability is reported, the network | | | |
| cannot select a pattern with a number of | | | |
| switching points greater than the value | | | |
| reported by the UE. | | | |
| If this UE capability is not reported, the | | | |
| network does not need to consider the | | | |
| number of switching points (which may also | | | |
| be referred to as the number of switching) | | | |
| when selecting a pattern. | | | |

An example of the second UE capability according to embodiments of the disclosure is expressed as follows:

$$FDD - SDL Number of switching points = enumerated \{ 1 , 2 , 3 , 4 , 5 \} .$$

Enumerated {1, 2, 3, 4, 5} may represent selecting a value from 1, 2, 3, 4, 5.

Further, as shown in Table 3 above, “BC/UE” means that the second UE capability may be reported per band combination (per BC), or may be reported per UE; “optional” means that the second UE capability may be an optional UE capability; “FR1 only” means that the second UE capability only applies to frequency range 1 (FR1) and not to frequency range 2 (FR2).

The second UE capability may be used to assist the network in the selection/configuration of patterns. For example, if the UE reports that it supports up to 3 switching between different carriers within a frame, the NW cannot configure the UE with a pattern with a switching number greater than 3.

According to embodiments of the disclosure, the UE may transmit the first UE capability and the second UE capability together to the base station, or may first transmit the first UE capability to the base station, and transmit the second UE capability to the base station.

2.4 New RRC signaling: RRC signaling_1, “FDD-SDL switching configuration”, which may be used for the NW to configure the UE with a switching pattern of each frame, which may be referred to herein as first configuration information. As described above, the first configuration information may include a frame pattern for one or more frames of the UE, and the frame pattern may include types of each subframe and/or slot and/or symbol in a frame.

In some implementations, the UE may receive one or more first configuration information from the BS. Each of the one or more first configuration information may indicate a switching pattern over a plurality of time units. The plurality of time units may include a first time unit and a second time unit. In the first time unit, the UE and/or BS may receive and/or transmit only on the first cell. In the second time unit, the UE and/or BS may receive and/or transmit only on the second cell.

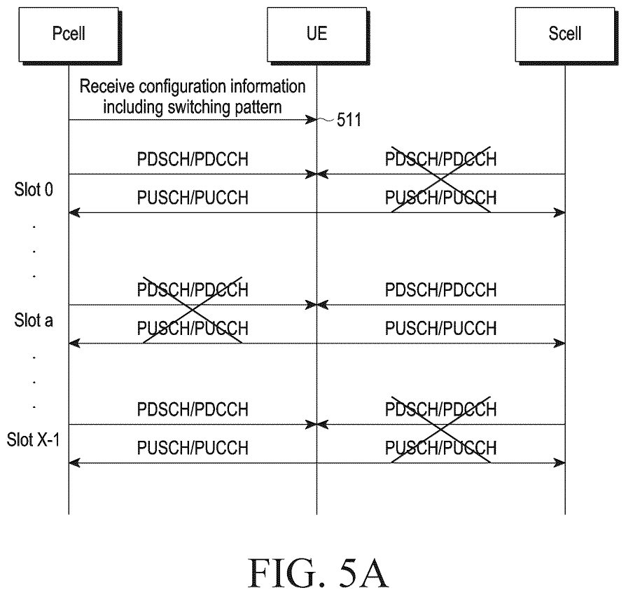

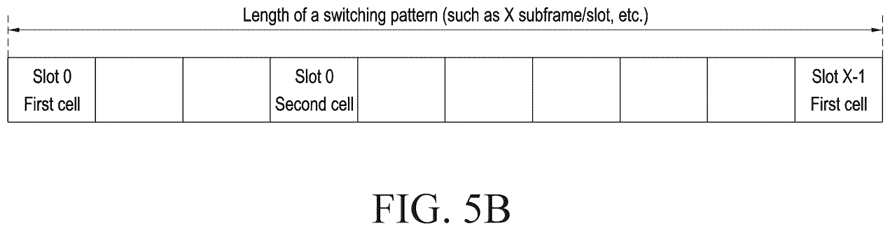

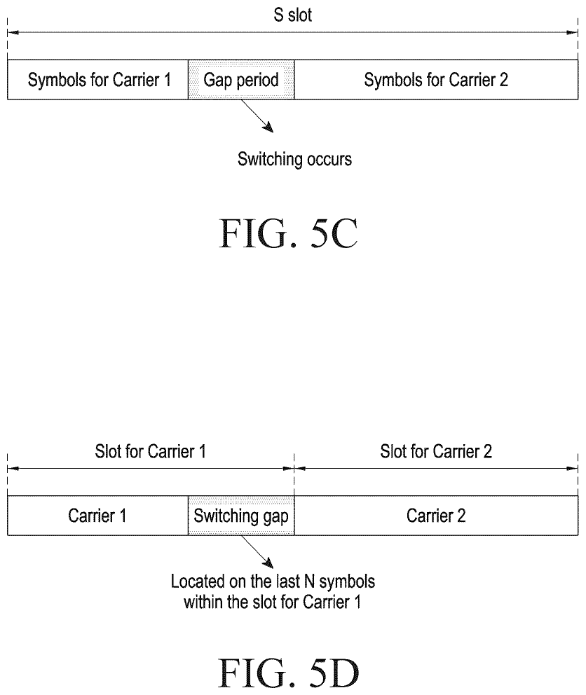

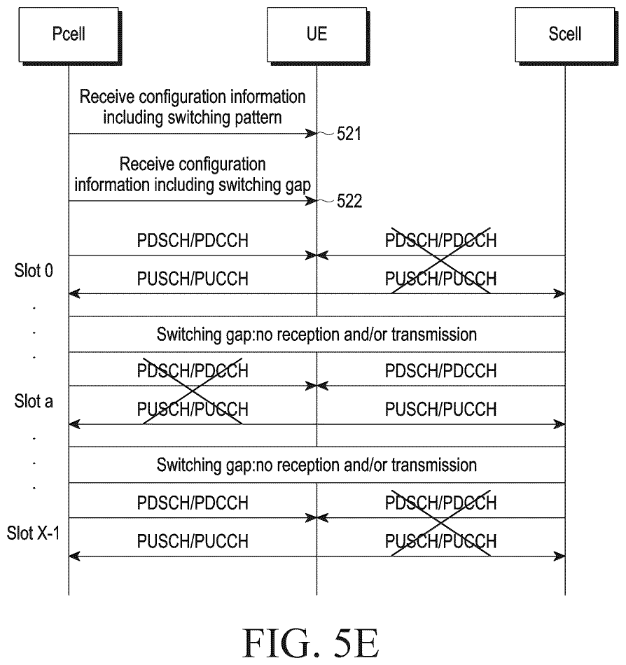

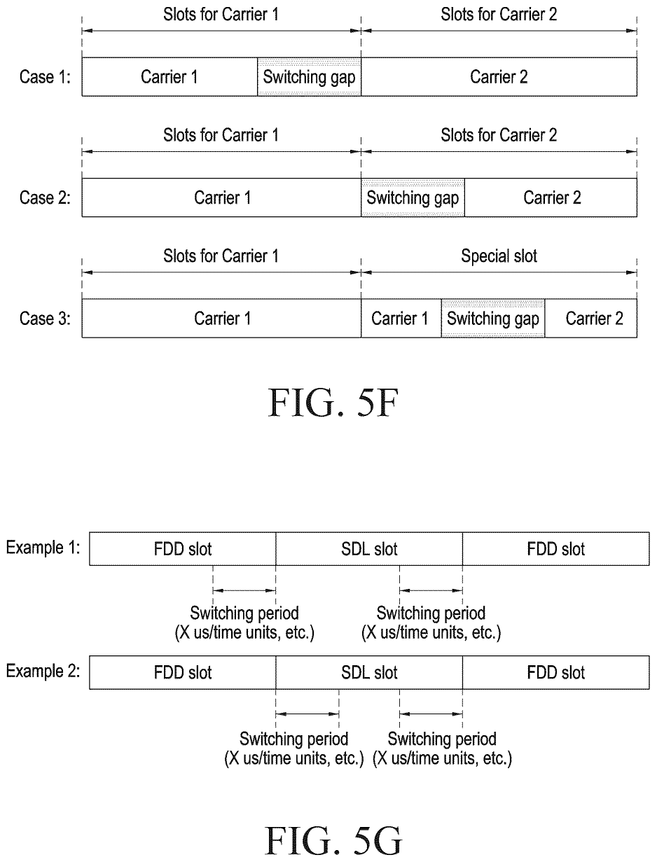

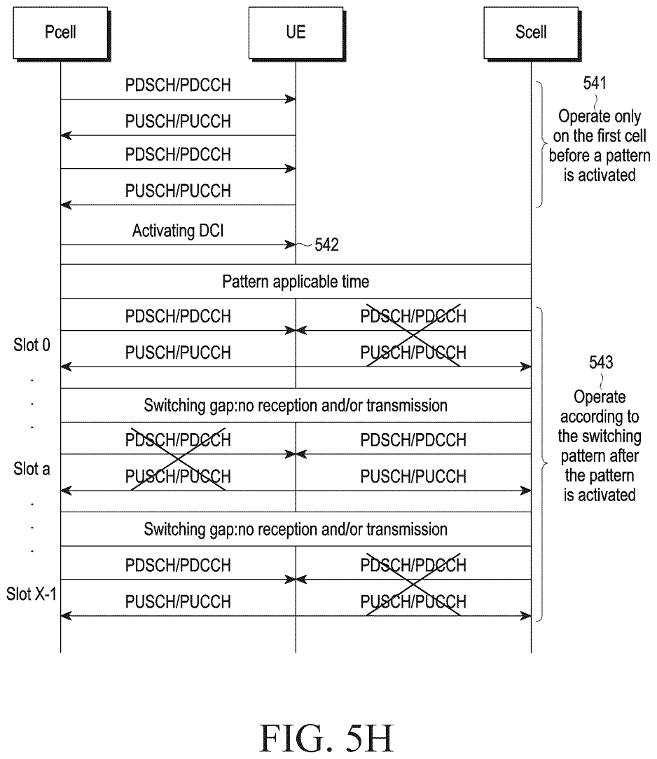

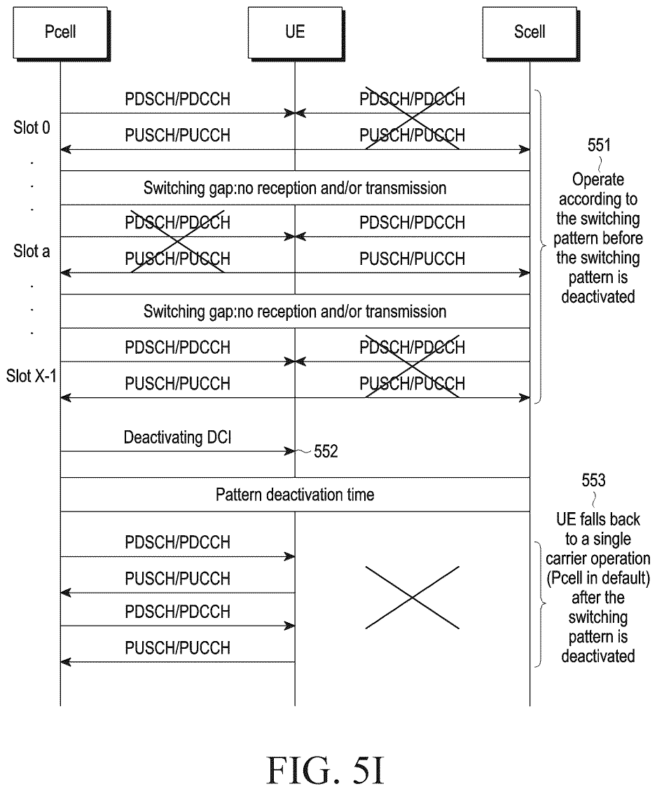

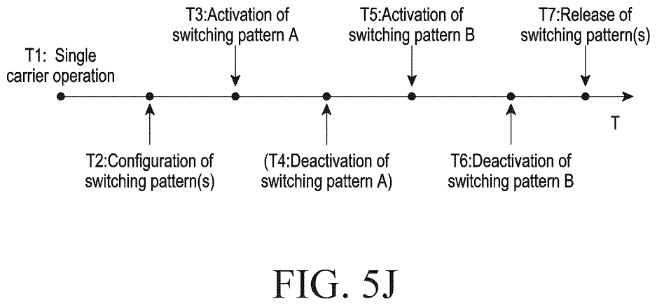

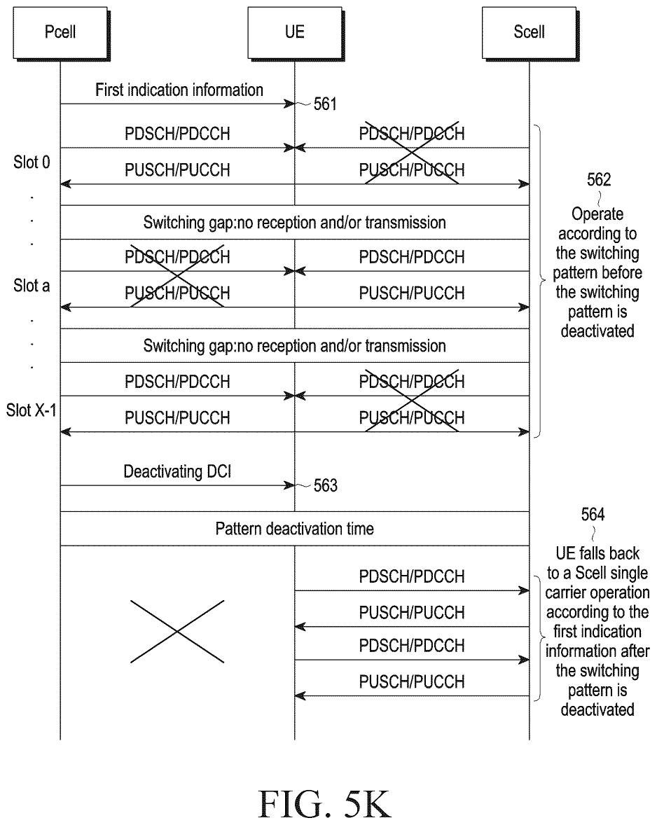

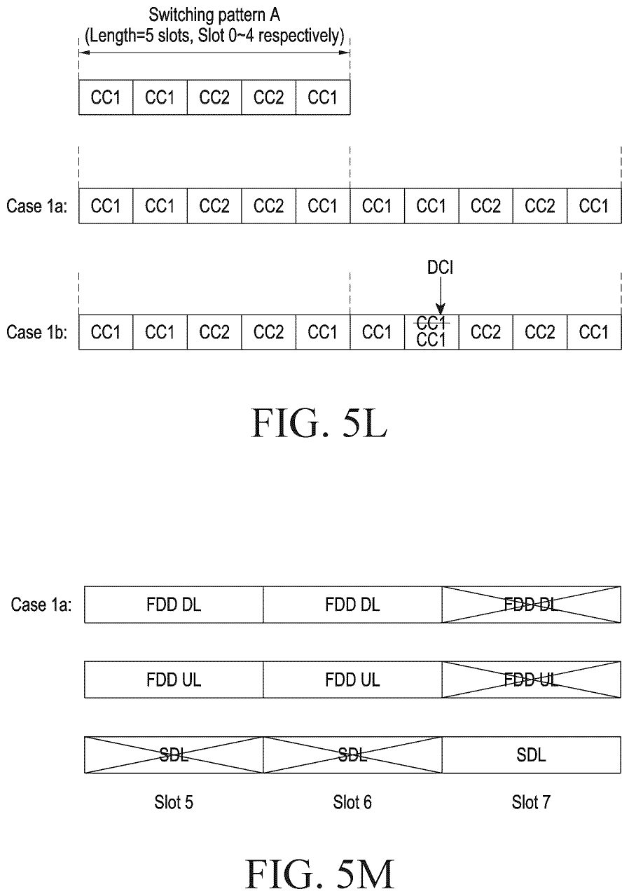

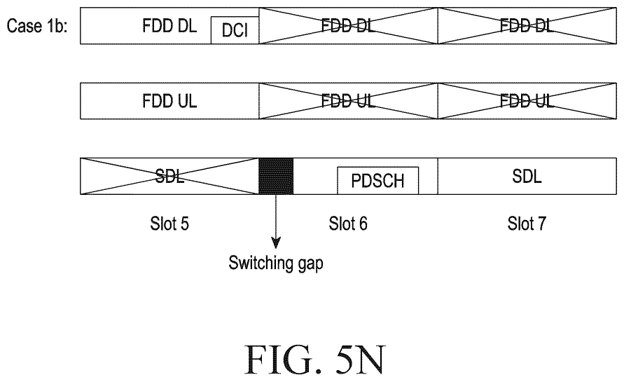

FIG. 5A illustrates an example in which the UE receives and/or transmits on different cells in different time units according to received first configuration information according to an embodiment of the disclosure. FIG. 5B illustrates an example of a switching pattern according to an embodiment of the disclosure.

Referring to FIG. 5A, in operation 511, the UE may receive configuration information including a switching pattern from the BS (e.g., through an RRC message, etc.). Assume that as shown in FIG. 5B, the switching pattern indicates the UE to: in slot 0, receive and/or transmit only on a first cell; in slot a, receive and/or transmit only on a second cell; in slot X−1, receive and/or transmit only on the first cell. Therefore, after receiving and/or activating and/or applying the switching pattern, the UE may receive and/or transmit only on the first cell in slot 0, receive and/or transmit only on the second cell in slot a, and receive and/or transmit only on the first cell in slot X−1 according to the switching pattern. In an example, the first cell may be a primary cell (Pcell) in CA, such as an FDD cell, etc.; the second cell may be a secondary cell (Scell) in CA, such as an SDL cell, etc.

In some implementations, the first configuration information may include a bitmap. A length of the bitmap (e.g., the number of bits in the bitmap) may correspond to or be equal to a total number of the plurality of time units. A bit in the bitmap corresponding to the first time unit may have a first value (e.g., 0 or 00, etc.), and a bit in the bitmap corresponding to the second time unit may have a second value different from the first value (e.g., 1 or 01, etc.).

For example, if the design of the pattern described in Section 2.1 is such that each subframe may be flexibly configured as FDD, SDL or S, the RRC signaling of the configuration of the NW to the UE may be defined in the form of a bitmap, in which, for example, there are a total of twenty bits, every two bits from left to right correspond to subframe 0 to subframe 9, and every two bits may be used to select one of FDD, SDL or S. For example, 00, 01, 10 may be used to represent FDD, SDL, S, etc., respectively.

An example of the first configuration information according to embodiments of the disclosure is expressed as follows:

$$FDD - SDL switching configuration = BIT string ( SIZE ( 1 … 20 ) ) .$$

In some implementations, the UE may receive second configuration information from the BS. The second configuration information may indicate a switching pattern among the first cell, the second cell, and the gap period in a special time unit of the plurality of time units (e.g., a special subframe of the plurality of subframes).

In some implementations, in the special time unit, the UE and/or the BS may receive and/or transmit on the first cell and the second cell in a time division multiplexing (TDM) manner based on the switching pattern indicated by the second configuration information.

As described above, the special time unit may be a time unit that may be configured to include at least one of a time resource for the first cell, a time resource for the second cell, and a time resource for the gap period.

Specifically, FIG. 5C illustrates an example of a configuration of a special slot according to embodiments of the disclosure.

Referring to FIG. 5C, the S slot may include symbols for Carrier 1, a gap period, and symbols for Carrier 2. The symbols for the gap period may be located between the symbols for Carrier 1 and the symbols for Carrier 2.

Furthermore, if a certain subframe is configured as S, S needs to be further configured. The NW configures the UE through another new RRC signaling “S FDD-SDL pattern” (which may be referred to herein as second configuration information). The configuration information may include three parameters X, Y, L, where X may represent the number of symbols used for FDD in the special subframe S, Y may represent the number of symbols used for SDL in the special subframe S, and the number of symbols used for the gap period is 14-X-Y (assuming that 1 subframe may include 14 symbols), L may represent the relevant information of the component carrier corresponding to the first symbol (or referred to as a starting symbol) in the special subframe S, for example, information related to whether the starting symbol in the special subframe S is a symbol used for FDD or a symbol used for SDL. For example, assuming that L is represented by 1 bit, L=0 indicates that the starting symbol is an FDD symbol, and L=1 indicates that the starting symbol is an SDL symbol. When X=3, Y=5, L=0, it may mean that the starting symbol in the special subframe S is an FDD symbol, and the first 3 symbols are all FDD symbols, the last 5 symbols are SDL symbols, and the middle 6 symbols (14-3-5) are for gap periods. More generally, in the case where there are at least two component carriers, the second configuration information may include the numbers of symbols respectively corresponding to each component carrier included in the special subframe.

In this way, the configuration of switching patterns may be made more flexibly on smaller time units (e.g., symbols) according to network requirements.

Optionally, if there are limited patterns preset, the network may directly select one of the patterns and configure it to the UE without having to configure each subframe for the UE one by one.

For example, the signaling may be designed in the form of a bitmap as shown in FDD-SDL switching configuration=BITstring {0, 1, 2, 3, 4, 5, 6, 7, . . . } (the length of the bitmap corresponds to the total number of the patterns), where the leftmost bit corresponds to pattern 0, the next bit corresponds to pattern 1, the other next bit corresponds to pattern 2, and so on. When the NW configures the UE with pattern 0, the leftmost bit is set to 1, and the other bits are set to 0; when the NW configures the UE with pattern 1, the second bit from the left is set to 1, and the other bits are set to 0, and so on.

Alternatively, the signaling may be designed in the form of: FDD-SDL switching configuration=enumerated {0, 1, 2, 3, 4, 5, 6 . . . }, in which the pattern number is directly reported.

When selecting a pattern, the NW may consider the switching period and number of switching points reported by the two UE capabilities introduced in sections 2.2 and 2.3, in conjunction with the load status and deployment scenarios of each cell in CA to make a reasonable selection.

The first configuration information according to embodiments of the disclosure may be used by the NW to indicate to the UE how SDL and FDD switch in a certain frame. As mentioned before, the pattern may vary from frame to frame. Without the indication, the UE may not know how to perform switching between FDD and SDL cells. In addition, through semi-static configuration of switching patterns, more reasonable signaling overhead may be achieved, avoiding fully dynamic configurations such as configuration per slot. In addition, compared to a manner of cell handover, the method of configuring switching patterns according to embodiments of the disclosure may have smaller delay, less energy consumption, and shorter interruption time.

2.5 New RRC signaling: RRC signaling_3 (which may be referred to herein as third configuration information), “SwitchingCarrier”, which may be used for the NW to configure the UE whether switching occurs on an FDD subframe, an SDL subframe, an FDD symbol in a special subframe, an SDL symbol in a special subframe, or a gap period in a special subframe. More generally, in the case where there are at least two component carriers, the location where carrier switching occurs may include at least one of the following: subframes for each of the at least two component carriers, symbols for each of at least two component carriers in a special subframe, and the gap period in a special subframe. More generally, in some examples, the third configuration information may include configuration information indicating the location and/or length of a switching gap (or gap period), etc. FIG. 5D illustrates an example of a switching gap according to an embodiment of the disclosure. Specifically, FIG. 5D shows a case where the switching gap is located on the last N symbols in the slot for the first cell (e.g., Carrier 1).

FIG. 5E illustrates an example in which the UE receives and/or transmits on different cells in different time units according to received first configuration information and third configuration information according to an embodiment of the disclosure.

Referring to FIG. 5E, in operation 521, the UE may receive configuration information including a switching pattern from the BS (e.g., through an RRC message, etc.). In operation 522, the UE may receive configuration information indicating the location and/or length of the switching gap (or gap period), etc., from the BS (e.g., through an RRC message, etc.). After receiving and/or activating and/or applying the switching pattern and the third configuration information, the UE may receive and/or transmit according to the switching pattern and the third configuration information. For example, as shown in FIG. 5E, in the switching gap indicated in the third configuration information, the UE and/or BS are not expected to receive and/or transmit any data or control signals.

An example of configuration information for indicating a location where the switching occurs included in the third configuration information according to embodiments of the disclosure is expressed as follows:

$$SwitchingCarrier = enumerated \{ FDD , SDL , S - FDD , S - SDL , S - Gap \} .$$

After completing the pattern configuration to the UE, the NW may further configure the carrier switching location to the UE through the “SwitchingCarrier” in combination with information such as the load status of each cell in the CA mode and actual scenario requirements. The carrier switching location may be located on a switch-from carrier (the carrier to be switched away from) or a switch-to carrier (the carrier to be switched to) or on an S subframe.

More specifically, the carrier switching location may include one or more of the following: on the FDD subframe, on the SDL subframe, on the FDD symbol in the S subframe, on the SDL symbol in the S subframe, on the gap period in the S subframe. Correspondingly, one of {FDD, SDL, S-FDD, S-SDL, S-Gap} may be selected for reporting. Different switching patterns may have the same or different switching locations.

FIG. 5F illustrates examples of different switching gap locations according to an embodiment of the disclosure.

Referring to FIG. 5F, Case 1 illustrates an example case of switching from Carrier 1 to Carrier 2, and the switching gap is configured in the slots for Carrier 1; Case 2 illustrates an example case of switching from Carrier 1 to Carrier 2, and the switching gap is configured in the slots for Carrier 2; Case 3 illustrates an example case of switching from Carrier 1 to Carrier 2, and the switching gap is configured in a special slot after the slots for Carrier 1. It should be understood that, in addition to the above example cases, the disclosure may also include switching from Carrier 2 to Carrier 1, switching from Carrier 2 to a special slot, switching from a special slot to Carrier 1, switching from a special slot to Carrier 2, etc., and any other similar cases, which will not be described again herein.

If the UE does not receive this indication from the network, the UE may autonomously select where to perform switching according to the pattern.

An example of the configuration information for indicating the length of the switching gap included in the third configuration information according to embodiments of the disclosure is expressed as follows:

$$SwitchingCarrier\_SymbolAmount = enumerated \{ 1 , … , 14 \} .$$

In the above examples, the length of the switching gap is in a symbol level. In other examples, the switching gap length may also be in unit of any other time unit, which is not limited in the disclosure. Different switching patterns may have the same or different switching gap lengths.

In some implementations, the length of the switching gap configured by the NW (or BS) to the UE may be determined based on one or more of the switching period required for the UE to switch between the first cell and the second cell included in the first UE capability reported by the UE, UL and DL timing advances, etc. For example, the length of the switching gap configured by the NW (or BS) to the UE should be greater than or equal to the switching period required for the UE to switch between the first cell and the second cell included in the first UE capability reported by the UE.

FIG. 5G illustrates examples of switching periods according to an embodiment of the disclosure.

Specifically, Example 1 in FIG. 5G shows the case where when switching from an FDD slot to an SDL slot, the switching period is located within the FDD slot, and when switching from an SDL slot to an FDD slot, the switching period is located within the SDL slot. Example 2 in FIG. 5G shows the case where when switching from an FDD slot to an SDL slot, the switching period is within an SDL slot, and when switching from an SDL slot to an FDD slot, the switching period is within an SDL slot. The switching period may be absolute time (e.g., X us, etc.) or X time units, etc.

If, in a subframe or slot, the switching gap or gap period starts at the first symbol of the subframe or slot and/or ends at the last symbol of the subframe or slot, the switching gap or gap period may not be considered as a special subframe or slot.

During the switching (or switching gap or switching period or gap period), the UE and/or BS are not expected to receive and/or transmit any data or control signals.

The network may flexibly select when to switch according to the scenario, cell load status, the pattern selected and configured to the UE by the network, mode, TA (UL and DL timing advance) and other information. For example, if UL coverage is more needed, the switching may be configured in the SDL carrier (if any); if the goal is to avoid impact on PDCCH, the switching may always be configured on the switch-to carrier.

2.6 New UE capability: UE capability_3 (which may be referred to herein as a third UE capability), “Swiching-Powerboosting”. The third UE capability may be used to indicate that the UE is capable of supporting power boosting when the UE switches between the at least two component carriers. For example, in case that a single FDD band has a higher power class than the FDD+SDL_CA, when the UE operates in an FDD+SDL_CA via switching mode and switches to FDD, the UE may be allowed to report a higher power class capability so that the network may further boost the power of the UE, which may be indicated by the third UE capability.

Table 4 illustrates an example of the third UE capability according to embodiments of the disclosure.

TABLE 4

| | | | |
|---|---|---|---|
| Switching-PowerBoosting | BC | optional | FR1 Only |
| It indicates the support of 3 dB or 6 dB | | | |
| boosting on the maximum output power for | | | |
| UE transmission under the operation state | | | |
| in which the operated subframe/slot is FDD | | | |
| or TDD. | | | |
| A UE shall only indicate this capability in | | | |
| case the UE supports a higher power class | | | |
| for “single band operation” than for carrier | | | |
| aggregation. | | | |
| Only when the UE reports UE capability 1, | | | |
| the UE can further report this capability | | | |
| If the UE does not report this capability, it | | | |
| means that the UE does not support | | | |
| transmitting higher power in a CA vis | | | |
| switching mode | | | |

As shown in Table 4 above, “BC” indicates that the third UE capability may be reported per-band combination (per BC); “optional” means that the third UE capability may be an optional UE capability; “FR1 only” means that the third UE capability only applies to frequency range 1 (FR1) and not to frequency range 2 (FR2).

For example, the highest power class defined for CA_n5-n29 is PC3, and the highest power class defined for single band operation n5 is PC2. As long as configured in a CA mode, the UE must follow the power class reported for CA but not the power class for single band operation, e.g., for CA_n5-n29, the power class of n5 may only reach PC3 but not PC2. This causes the FDD PA (Power Amplification) capability not to be fully utilized.

However, through the third UE capability according to embodiments of the disclosure, the UE may inform the network that in the CA via switching mode, when the UE switches to the FDD band, the UE may transmit higher power.

Through the interaction of this UE capability and/or related configuration information, the power amplification (PA) capability of FDD may be fully utilized, thereby enabling the UE to transmit higher power to achieve better coverage.

2.7 New DCI format: for example, activating DCI, which may be used to indicate to the UE that at least one of the one or more configured switching patterns is activated. The activating DCI may also be referred to as a first DCI format. In some implementations, the UE may be allowed to be configured with one or more different switching patterns, but only one of the switching patterns may be applied and/or activated at a time.

FIG. 5H illustrates an example in which a UE receives DCI for activating a switching pattern according to an embodiment of the disclosure.

Referring to FIG. 5H, in operation 541, before one or more switching patterns received by the UE are activated, the UE may perform receiving and/or transmitting operations only on the first cell (e.g., Pcell).

In operation 542, the UE may receive a first DCI format from a BS (e.g., a first cell). The first DCI format may include information indicating that a switching pattern indicated by one of the one or more first configuration information received by the UE is activated. For example, the first DCI format may include information for activating a first switching pattern of the received one or more switching patterns.

After a first time after receiving the first DCI format, the UE may apply the first switching pattern. The first time may be a processing time for the UE to apply and/or activate and/or change the switching pattern. The first time may also be referred to as a pattern applicable time, a pattern activating time, or any other name, which is not limited in the disclosure.

In operation 543, after activating the first switching pattern (e.g., after the first time), the UE may perform receiving and/or transmitting operations according to the first switching pattern.

For example, in a first time unit (e.g., slot 0, slot X−1, etc.) after the first time, the UE may receive and/or transmit only on the first cell. In a second time unit (e.g., slot a, etc.) after the first time, the UE may receive and/or transmit only on the second cell.

If the UE is only configured with one switching pattern, change of the switching pattern needs to be performed with operations such as RRC reconfiguration, which is time-consuming. However, through the method proposed in the disclosure, in which the UE is configured with multiple switching patterns and one of them is activated by the activating DCI, fast pattern switching (e.g., in a symbol level) may be achieved, thereby effectively adapting to real-time network traffic requirements.

2.8 New DCI format: for example, deactivating DCI, which may be used to indicate to the UE that at least one of the one or more configured switching patterns is deactivated. The deactivating DCI may also be referred to as a second DCI format.

FIG. 5I illustrates an example in which a UE receives DCI for deactivating a switching pattern according to an embodiment of the disclosure.

Referring to FIG. 5I, in operation 551, before the second switching pattern currently being applied by the UE is deactivated (and/or before the UE receives a deactivating DCI for deactivating the second switching pattern), the UE may perform receiving and/or transmitting operations according to the second switching pattern.

For example, before the deactivation, in a first time unit (e.g., slot 0, slot X−1, etc.), the UE may receive and/or transmit only on a first cell. In a second time unit (e.g., slot a, etc.), the UE may receive and/or transmit only on the second cell.

In operation 552, the UE may receive a second DCI format from a BS (e.g., a first cell). The second DCI format may include information indicating that the switching pattern indicated by one of the one or more first configuration information received by the UE is deactivated. For example, the second DCI format may include information for deactivating the second switching pattern. For example, the second switching pattern may be the first switching pattern previously activated, or any other switching pattern previously activated.

After a second time after receiving the second DCI format, the UE may deactivate the second switching pattern. The second time may be the processing time for the UE to deactivate and/or change the switching pattern. The second time may also be referred to as a pattern deactivating time, or any other name, which is not limited in the disclosure.

In operation 553, after deactivating the second switching pattern (e.g., after the second time), the UE may fall back to a single carrier operation, e.g., the UE may perform receiving and/or transmitting operations only on the first cell (e.g., Pcell).

In some implementations, after deactivating the second switching pattern (e.g., after the second time), the UE may fall back to the Pcell to perform receiving and/or transmitting operations by default.

In some implementations, the second time and the first time may have the same or different lengths.

In some implementations, assuming that the UE is currently applying switching pattern A, if the UE receives an activating DCI for switching pattern B, deactivating DCI for switching pattern A may be omitted. In this case, the pattern applicable time (e.g., the first time) of switching pattern B may be the maximum value of the activation time of switching pattern B and the deactivation time of switching pattern A. In this case, the UE may not fall back to a single carrier operation (e.g., switching pattern B may be activated at the same time as switching pattern A is deactivated, or immediately after the time when switching pattern A is deactivated).

FIG. 5J illustrates an example timing diagram of activation and deactivation of switching patterns according to an embodiment of the disclosure.

Referring to FIG. 5J, at time T1, the UE may be in a single carrier operation. At time T2, the UE may be configured with one or more switching patterns. At time T3, switching pattern A may be activated. At time T4, switching pattern A may be deactivated. At time T5, switching pattern B may be activated. At time T6, switching pattern B may be deactivated. At time T7, one or more switching patterns may be released.

Through the methods proposed by the disclosure in which the UE is configured with multiple switching patterns and one of them is activated by the activating DCI and/or one of them is deactivated by the deactivating DCI, fast pattern switching (e.g., in a symbol level) may be achieved, thereby effectively adapting to real-time network traffic requirements.

2.9 New indication information: for example, FallbacktoScell, which may be used to indicate that the UE receives and/or transmits only on a second cell (e.g., Scell in CA, or any other cell in CA) after a switching pattern is deactivated. The indication information may also be referred to as first indication information.

FIG. 5K illustrates an example in which a UE receives first indication information according to an embodiment of the disclosure.

Referring to FIG. 5K, in operation 561, the UE may receive first indication information (e.g., through an RRC message, etc.) from the BS (e.g., the first cell). The first indication information may be used to indicate the UE to receive and/or transmit only on the second cell (e.g., the Scell in CA, or any other cell in CA) after the switching pattern is deactivated (e.g., after the second time after receiving the deactivating DCI).

In operation 562, before the second switching pattern currently being applied by the UE is deactivated (and/or before the UE receives the deactivating DCI for deactivating the second switching pattern), the UE may perform receiving and/or transmitting operations according to the second switching pattern.

For example, before the deactivation, in a first time unit (e.g., slot 0, slot X−1, etc.), the UE may receive and/or transmit only on a first cell. In a second time unit (e.g., slot a, etc.), the UE may receive and/or transmit only on the second cell.

In operation 563, the UE may receive a second DCI format from the BS (e.g., the first cell). The second DCI format may include information indicating that the switching pattern indicated by one of the one or more first configuration information received by the UE is deactivated. For example, the first DCI format may include information for deactivating the second switching pattern.

After a second time after receiving the second DCI format, the UE may deactivate the second switching pattern. The second time may be the processing time for the UE to deactivate and/or change the switching pattern. The second time may also be referred to as a pattern deactivating time, or any other name, which is not limited in the disclosure.

In operation 564, after deactivating the second switching pattern (e.g., after the second time), the UE may fall back to a single carrier operation according to the first indication information. For example, the UE may fall back to the second cell (e.g., Scell) indicated by the first indication information, and perform receiving and/or transmitting operations only on the second cell.

It should be understood that the order of the above operations is only an example, and the first indication information may be received at any time before or at the same time as the UE receives the deactivating DCI, which is not limited in the disclosure.

In some implementations, if the UE is configured with the first indication information, the UE may fall back to a single carrier operation of the Scell after deactivating the second switching pattern (e.g., after the second time); if the UE is not configured with the first indication information, the UE may fall back to a single carrier operation of the Pcell by default after deactivating the second switching pattern (e.g., after the second time).

In some implementations, in the case of two carriers, if one of the two carriers cannot be configured as a Pcell (e.g., an SDL carrier without uplink resources), the UE may only fall back to the other carrier that may be configured as a Pcell. A carrier of a Pcell (e.g., an FDD carrier with uplink and downlink resources, etc.). In this case, the NW does not need to transmit the first indication information to the UE, or the UE may ignore the received first indication information.

By this way of RRC signaling indicating the fallback cell (e.g., RRC signaling usually takes only about 20 milliseconds), it can be avoided that the UE is switched to another cell by means of cell handover after the switching pattern is deactivated (e.g., it usually takes 40 to 120 milliseconds), thereby effectively saving switching period.

2.10 New DCI format: for example, a third DCI format, which may be used to indicate to the UE to receive and/or transmit on a first cell in a second time unit. For example, in the case where the UE should receive and/or transmit on a second cell in the second time unit according to an applied or activated switching pattern, after the UE receives the third DCI format from the BS, it may receive and/or transmit on the first cell in the second time unit.

For example, in some implementations, the UE may receive a third DCI format, where the third DCI format may indicate the UE to receive and/or transmit on the first cell in the second time unit. After receiving the third DCI format, the UE may receive and/or transmit on the first cell in the second time unit according to the scheduling of the third DCI format.

2.11 New DCI format: for example, a fourth DCI format, which may be used to indicate to the UE to receive and/or transmit on a second cell in a first time unit. For example, in the case where the UE should receive and/or transmit on a first cell in the first time unit according to an applied or activated switching pattern, after the UE receives the fourth DCI format from the BS, it may receive and/or transmit on the second cell in the first time unit.

For example, in some implementations, the UE may receive a fourth DCI format, where the fourth DCI format may indicate the UE to receive and/or transmit on the second cell in the first time unit. After receiving the fourth DCI format, the UE may receive and/or transmit on the second cell in the first time unit according to the scheduling of the fourth DCI format.

For example, in the case of two carriers (or cells) CC1+CC2, an example of the third DCI format and/or the fourth DCI format is expressed as follows:

$$DynamicScheduling = enumerated \{ CC 1 , CC 2 \} .$$

By default, which cell the UE should receive and/or transmit on in each time unit may follow the currently activated and/or applied switching pattern. When the UE receives the third DCI format/fourth DCI format, and the carrier on which it indicates to perform reception and/or transmission on a certain time unit is inconsistent with the corresponding carrier in the switching pattern, the UE should follow the indication of the third DCI format/fourth DCI format, and receive and/or transmit on the indicated carrier on the certain time unit.

For example, assume that based on the currently activated and/or applied switching pattern, the UE should receive and/or transmit on the first cell (e.g., CC1) in slot a. However, when the UE receives the third DCI format/fourth DCI format, which indicates that the UE receives and/or transmits on the second cell (e.g., CC2) in slot a, the UE should follow the third DCI format/fourth DCI format indication to receive and/or transmit on the second cell.

In some implementations, the third DCI format and/or the fourth DCI format may be configured for one or more time units.

In some implementations, the switching gap location configured for the UE may remain unchanged.

In this way, rapid load balancing adjustments may be made to suit the required real-time traffic. Furthermore, signaling overhead may be greatly reduced compared to fully dynamic scheduling (e.g., configuring carriers on each time unit individually).

FIGS. 5L to 5N illustrate examples of changing applied switching patterns through DCI according to various embodiments of the disclosure.

Referring to FIG. 5L, it is assumed that the switching pattern currently applied by the UE is switching pattern A, and the length is 5 slots, slots 0 to 4 respectively. In the default case (e.g., Case 1a), the UE will repeat switching pattern A for reception and/or transmission. In Case 1b, assuming that the UE receives DCI indicating the UE to receive and/or transmit on the second cell in a specific slot (e.g., slot 6), the UE will repeat the updated switching pattern (e.g., CC1, CC2, CC2, CC2, CC1) afterward.

More specifically, it is assumed that the first cell is an FDD cell, the second cell is an SDL cell, and the switching gap is located in the SDL cell. Taking slot 5, slot 6 and slot 7 among the 10 slots as an example, as shown in FIG. 5M, in Case 1a, according to switching pattern A, in slot 5 and slot 6, the UE performs uplink and downlink transmission in the FDD cell; in slot 7, the UE performs downlink reception in the SDL cell. Referring to FIG. 5N, in Case 1b, assuming that the UE receives DCI in slot 5 indicating the UE to perform downlink reception (e.g., PDSCH reception) on the SDL cell in slot 6, both in slot 6 and slot 7, the UE will perform downlink reception on the SDL cell.

FIG. 5O illustrates a schematic diagram of exchanging of UE capability and configuration information between a UE and a NW according to an embodiment of the disclosure.

Referring to FIG. 5O, the UE may be configured in an FDD band-SDL band carrier aggregation via switching mode, and the NW may be a base station or any other node on the network side.

In operation 501, the UE may transmit a first UE capability “FDD-SDL switching period” to the NW.

In operation 502, the UE may transmit a second UE capability “FDD-SDL Number of switching points” to the NW.

In operation 503, the UE may transmit the third UE capability “Swiching-Powerboosting” to the NW. The UE capabilities may be transmitted through any suitable message or signaling such as RRC signaling, etc., which is not limited herein.

In operation 504, the NW may configure the UE with the pattern of each frame through the first configuration information “FDD-SDL switching configuration” according to one or more of the first UE capability and/or second UE capability reported by the UE, load status of each cell in the CA mode and actual deployment requirements, etc.

In operation 505, further, the NW may further configure the special subframe S in each frame through the second configuration information “S FDD-SDL pattern”.

In operation 506, according to one or more of the pattern configured by the NW to the UE in operations 504 and 505, the load status of each cell in the CA mode, actual scenario requirements, etc., the NW may further configure the UE with a carrier switching location through the third configuration information “SwitchingCarrier”.

In operation 507, the UE may start switching. During the time period when the UE performs carrier switching, the UE is not expected to receive or transmit any symbols. After the NW configures the UE with carrier switching, the UE must complete the switching within the reported supported maximum switching period (including FDD to SDL switching period and SDL to FDD switching period). The UE may perform carrier switching (e.g., switching between any two of the at least two carriers) based on one or more of the first configuration information, the second configuration information, and the third configuration information.

It should be understood that one or more of the example operations shown in FIGS. 5A to 5O may be performed individually or may be performed in combination in a single operation, which is not limited herein.

It should be understood that, depending on the application scenarios, the various example aspects, methods, operations, processes, etc. shown above in conjunction with the drawings may be implemented individually or combined in any manner, which is not limited herein.

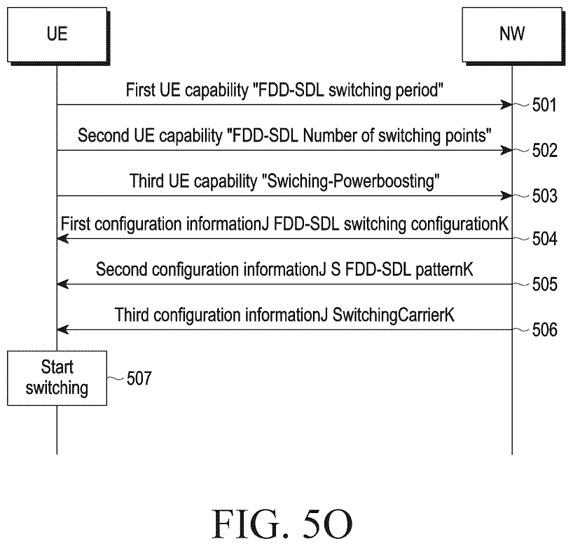

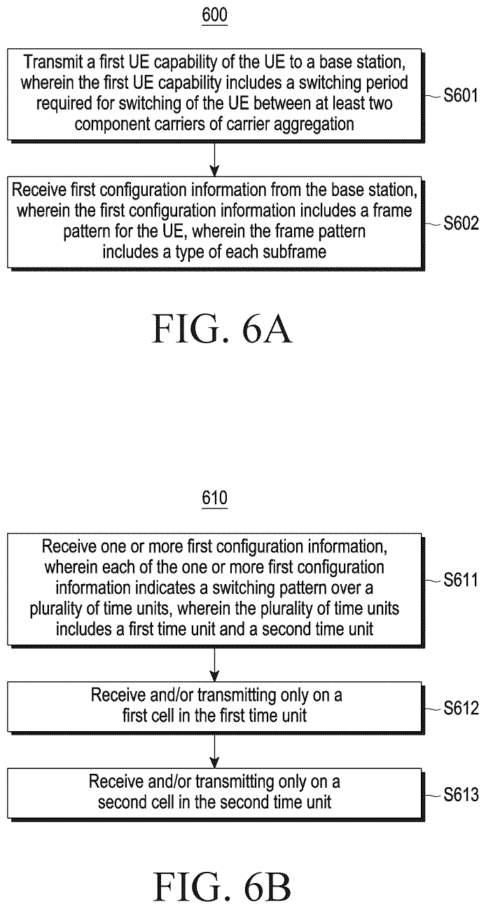

FIG. 6A illustrates a flowchart of a method 600 performed by a user equipment (UE) in a wireless communication system according to an embodiment of the disclosure.

Referring to FIG. 6A, a method 600 performed by a user equipment (UE) in a wireless communication system according to embodiments of the disclosure may include: in operation S601, transmitting a first UE capability of the UE to a base station, wherein the first UE capability may include a switching period required for switching of the UE between at least two component carriers of carrier aggregation; and in operation S602, receiving first configuration information from the base station, wherein the first configuration information may include a frame pattern for the UE, wherein the frame pattern may include a type of each subframe.

According to embodiments of the disclosure, the method may include: transmitting a second UE capability of the UE to the base station, wherein the second UE capability includes a maximum number of switching supported by the UE in one time unit.

According to embodiments of the disclosure, the method may include: receiving second configuration information related to a special subframe in the frame pattern from the base station, wherein the special subframe includes symbols used for each of the at least two component carriers and a gap period, wherein the second configuration information includes one or more of: numbers of symbols used for each of the at least two component carriers included in the special subframe, and information related to a component carrier corresponding to a starting symbol in the special subframe.

According to embodiments of the disclosure, the method may include: receiving third configuration information from the base station, wherein the third configuration information includes information related to a location where carrier switching occurs, wherein the location includes one or more of: subframes used for each of the at least two component carriers, symbols used for each of the at least two component carriers in a special subframe, the gap period in the special subframe.

According to embodiments of the disclosure, the method may include: transmitting a third UE capability of the UE to the base station, wherein the third UE capability indicates that power boosting is supported when the UE switches between the at least two component carriers.

According to embodiments of the disclosure, the time unit is a frame.

According to embodiments of the disclosure, the frame pattern may include: a switching periodicity.

According to embodiments of the disclosure, the type of subframe includes one or more of: subframes used for each of the at least two component carriers, a special subframe.

According to embodiments of the disclosure, the component carrier is one of the following: a supplementary downlink (SDL) component carrier, an FDD component carrier, and a time division duplex (TDD) component carrier.

According to embodiments of the disclosure, the method may include: performing switching between the at least two component carriers based on one or more of the first configuration information, the second configuration information and the third configuration information.

FIG. 6B illustrates a flowchart of a method 610 performed by a user equipment (UE) in a wireless communication system according to an embodiment of the disclosure.

Referring to FIG. 6B, a method 610 performed by a user equipment (UE) in a wireless communication system according to embodiments of the disclosure may include: in operation S611, receiving one or more first configuration information, wherein each of the one or more first configuration information indicates a switching pattern over a plurality of time units, wherein the plurality of time units may include a first time unit and a second time unit; in operation S612, receiving and/or transmitting only on a first cell in the first time unit; and in operation S613, receiving and/or transmitting only on a second cell in the second time unit.

According to embodiments of the disclosure, the first configuration information may include a bitmap, wherein a length of the bitmap corresponds to a total number of the plurality of time units, wherein a bit in the bitmap corresponding to the first time unit has a first value and a bit in the bitmap corresponding to the second time unit has a second value that is different from the first value.

According to embodiments of the disclosure, the method may include: transmitting first UE capability information, wherein the first UE capability information includes a switching period between the first cell and the second cell.

According to embodiments of the disclosure, the method may include: controlling not to receive and/or transmit during the switching period.

According to embodiments of the disclosure, the method may include: receiving a first downlink control information (DCI) format, wherein the first DCI format indicates that a first switching pattern indicated by one of the one or more first configuration information is activated; and applying the first switching pattern after a first time after receiving the first DCI format, wherein in a first time unit after the first time, the UE receives and/or transmits only on the first cell, and in a second time unit after the first time, the UE receives and/or transmits only on the second cell.

According to embodiments of the disclosure, the method may include: receiving a second downlink control information (DCI) format, wherein the second DCI format indicates that a second switching pattern indicated by one of the one or more first configuration information is deactivated.

According to embodiments of the disclosure, the method may include: receiving and/or transmitting only on the first cell after a second time after receiving the second DCI format.

According to embodiments of the disclosure, the method may include: receiving first indication information, wherein the first indication information indicates that the UE receives and/or transmits only on the second cell after the second switching pattern is deactivated.

According to embodiments of the disclosure, the method may include: receiving and/or transmitting only on the second cell after a second time after receiving the second DCI format.

According to embodiments of the disclosure, the method may include: receiving a third downlink control information (DCI) format, wherein the third DCI format indicates receiving and/or transmitting on the first cell in the second time unit; and receiving and/or transmitting on the first cell in the second time unit after receiving the third DCI format.

According to embodiments of the disclosure, the method may include: receiving a fourth downlink control information (DCI) format, wherein the fourth DCI format indicates receiving and/or transmitting on the second cell in the first time unit; and receiving and/or transmitting on the second cell in the first time unit after receiving the fourth DCI format.

According to embodiments of the disclosure, the method may include: receiving second configuration information, wherein the second configuration information indicates a switching pattern among the first cell, the second cell, and a gap period in a special time unit among the plurality of time units; and receiving and/or transmitting on the first cell and the second cell in a time division multiplexing (TDM) manner based on the switching pattern in the special time unit, wherein the special time unit is a time unit including time resources for the first cell, time resources for the second cell, and time resources for the gap period.

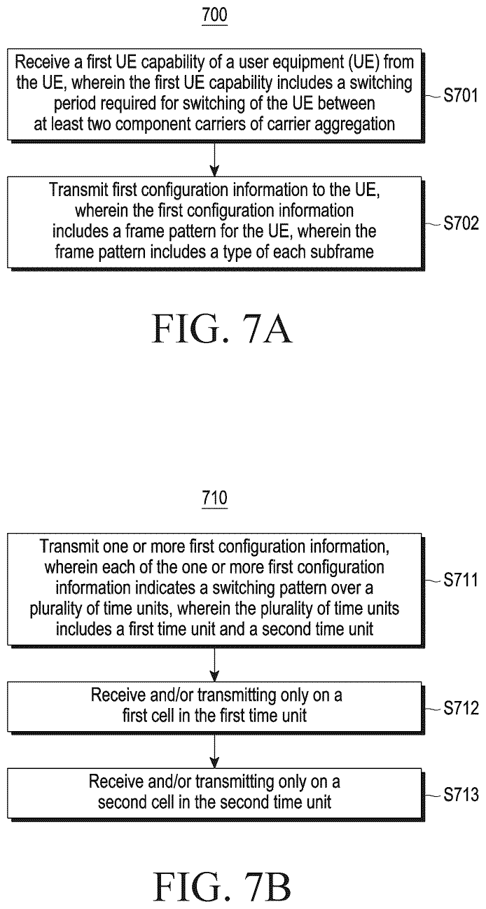

FIG. 7A illustrates a flowchart of a method 700 performed by a base station in a wireless communication system according to an embodiment of the disclosure.

Referring to FIG. 7A, a method 700 performed by a base station in a wireless communication system according to embodiments of the disclosure may include: in operation S701, receiving a first UE capability of a user equipment (UE) from the UE, wherein the first UE capability may include a switching period required for switching of the UE between at least two component carriers of carrier aggregation; and in operation S702, transmitting first configuration information to the UE, wherein the first configuration information may include a frame pattern for the UE, wherein the frame pattern may include a type of each subframe.

According to embodiments of the disclosure, the method may include: receiving a second UE capability of the UE from the UE, wherein the second UE capability includes a maximum number of switching supported by the UE in one time unit.

According to embodiments of the disclosure, the method may include: transmitting second configuration information related to a special subframe in the frame pattern to the UE, wherein the special subframe includes symbols used for each of the at least two component carriers and a gap period, wherein the second configuration information includes one or more of: numbers of symbols used for each of the at least two component carriers included in the special subframe, and information related to a component carrier corresponding to a starting symbol in the special subframe.

According to embodiments of the disclosure, the method may include: transmitting third configuration information to the UE, wherein the third configuration information includes information related to a location where carrier switching occurs, wherein the location includes one or more of: subframes used for each of the at least two component carriers, symbols used for each of the at least two component carriers in a special subframe, the gap period in the special subframe.

According to embodiments of the disclosure, the method may include: receiving a third UE capability of the UE from the UE, wherein the third UE capability indicates that power boosting is supported when the UE switches between the at least two component carriers.

According to embodiments of the disclosure, the time unit is a frame.

According to embodiments of the disclosure, the frame pattern may include: a switching periodicity.

According to embodiments of the disclosure, the type of subframe includes one or more of: subframes used for each of the at least two component carriers, a special subframe.

According to embodiments of the disclosure, the component carrier is one of the following: a supplementary downlink (SDL) component carrier, an FDD component carrier, and a time division duplex (TDD) component carrier.

According to embodiments of the disclosure, one or more of the first configuration information, the second configuration information and the third configuration information are used to perform switching between the at least two component carriers.

FIG. 7B illustrates a flowchart of a method 710 performed by a base station in a wireless communication system according to an embodiment of the disclosure.

Referring to FIG. 7B, a method 710 performed by a base station in a wireless communication system according to embodiments of the disclosure may include: in operation S711, transmitting one or more first configuration information, wherein each of the one or more first configuration information indicates a switching pattern over a plurality of time units, wherein the plurality of time units may include a first time unit and a second time unit; in operation S712, receiving and/or transmitting only on a first cell in the first time unit; and in operation S713, receiving and/or transmitting only on a second cell in the second time unit.

According to embodiments of the disclosure, the first configuration information may include a bitmap, wherein a length of the bitmap corresponds to a total number of the plurality of time units, wherein a bit in the bitmap corresponding to the first time unit has a first value and a bit in the bitmap corresponding to the second time unit has a second value that is different from the first value.

According to embodiments of the disclosure, the method may include: receiving first UE capability information, wherein the first UE capability information includes a switching period between the first cell and the second cell.

According to embodiments of the disclosure, the method may include: controlling not to receive and/or transmit during the switching period.

According to embodiments of the disclosure, the method may include: transmitting a first downlink control information (DCI) format, wherein the first DCI format indicates that a first switching pattern indicated by one of the one or more first configuration information is activated, wherein the first switching pattern is applied after a first time after a user equipment (UE) receives the first DCI format, and wherein in a first time unit after the first time, the UE receives and/or transmits only on the first cell, and in a second time unit after the first time, the UE receives and/or transmits only on the second cell.

According to embodiments of the disclosure, the method may include: transmitting a second downlink control information (DCI) format, wherein the second DCI format indicates that a second switching pattern indicated by one of the one or more first configuration information is deactivated.

According to embodiments of the disclosure, the method may include: receiving and/or transmitting only on the first cell after a second time after transmitting the second DCI format.

According to embodiments of the disclosure, the method may include: transmitting first indication information, wherein the first indication information indicates that the UE receives and/or transmits only on the second cell after the second switching pattern is deactivated.

According to embodiments of the disclosure, the method may include: receiving and/or transmitting only on the second cell after a second time after transmitting the second DCI format.

According to embodiments of the disclosure, the method may include: transmitting a third downlink control information (DCI) format, wherein the third DCI format indicates receiving and/or transmitting on the first cell in the second time unit; and receiving and/or transmitting on the first cell in the second time unit after transmitting the third DCI format.

According to embodiments of the disclosure, the method may include: transmitting a fourth downlink control information (DCI) format, wherein the fourth DCI format indicates receiving and/or transmitting on the second cell in the first time unit; and receiving and/or transmitting on the second cell in the first time unit after transmitting the fourth DCI format.

According to embodiments of the disclosure, the method may include: transmitting second configuration information, wherein the second configuration information indicates a switching pattern among the first cell, the second cell, and a gap period in a special time unit among the plurality of time units; and receiving and/or transmitting on the first cell and the second cell in a time division multiplexing (TDM) manner based on the switching pattern in the special time unit, wherein the special time unit is a time unit including time resources for the first cell, time resources for the second cell, and time resources for the gap period.

It should be understood that methods 600, 610, 700, 710, etc. according to embodiments of the disclosure may also include one or more of the methods or operations described above in conjunction with any example, aspect or drawing, which will not be described again here.

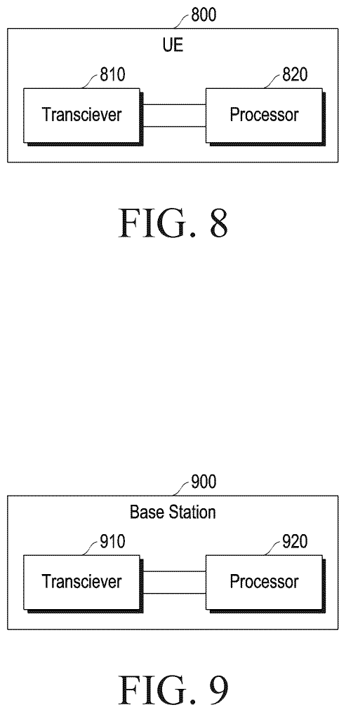

FIG. 8 illustrates a schematic diagram of a user equipment (UE) 800 in a wireless communication system according to an embodiment of the disclosure.

Referring to FIG. 8, a user equipment (UE) 800 according to embodiments of the disclosure may include a transceiver 810, a processor 820, and memory. The transceiver 810 may be configured to transmit and receive signals. The memory comprises one or more storage media and stores instructions. The processor 820 may be coupled to the transceiver 810 and the memory. The instructions, when executed by the one or more processors individually or collectively, cause the UE to perform any method performed by a user equipment (UE) in a wireless communication system according to embodiments of the disclosure.

FIG. 9 illustrates a schematic diagram of a base station 900 in a wireless communication system according to an embodiment of the disclosure.

Referring to FIG. 9, a base station 900 according to embodiments of the disclosure may include a transceiver 910, a processor 920, and memory. The transceiver 910 may be configured to transmit and receive signals. The memory comprises one or more storage media and stores instructions. The processor 920 may be coupled to the transceiver 910 and the memory. The instructions, when executed by the one or more processors individually or collectively, cause the base station to perform any method performed by a base station in a wireless communication system according to embodiments of the disclosure.

A node may also be referred to as a node device. A processor may also be referred to as a controller. Network may refer to a base station or any other node on the network side.

Embodiments of the disclosure also provide a computer-readable medium having stored thereon computer-readable instructions which, when executed by a processor, implement any method according to embodiments of the disclosure.

Various embodiments of the disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disc read-only memory (CD-ROM), magnetic tape, floppy disk, optical data storage device, carrier wave (e.g., data transmission via the Internet), etc. Computer-readable recording media may be distributed by computer systems connected via a network, and thus computer-readable codes may be stored and executed in a distributed manner. Furthermore, functional programs, codes and code segments for implementing various embodiments of the disclosure may be easily explained by those skilled in the art to which the embodiments of the disclosure are applied.

It will be understood that the embodiments of the disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital versatile disc (DVD), etc.). Non-transitory computer-readable recording media may also be distributed on computer systems coupled to a network, so that computer-readable codes are stored and executed in a distributed manner. The medium can be read by a computer, stored in memory, and executed by a processor. Various embodiments may be implemented by a computer or a portable terminal including a controller and memory, and the memory may be an example of a non-transitory computer-readable recording medium suitable for storing program(s) with instructions for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably may include its equivalents.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, by the UE, one or more first configuration information, wherein each of the one or more first configuration information indicates a switching pattern over a plurality of time units including a first time unit and a second time unit;
receiving and/or transmitting, by the UE, on a first cell in the first time unit; and
receiving and/or transmitting, by the UE, on a second cell in the second time unit.

2. The method of claim 1,
wherein the first configuration information includes a bitmap,
wherein a length of the bitmap corresponds to a total number of the plurality of time units,
wherein a first bit in the bitmap corresponding to the first time unit has a first value, and
wherein a second bit in the bitmap corresponding to the second time unit has a second value that is different from the first value.

3. The method of claim 1, further comprising:
transmitting first UE capability information including a switching period between the first cell and the second cell; and
controlling not to receive and/or transmit during the switching period.

4. The method of claim 1, further comprising:
receiving a first downlink control information (DCI) format, wherein the first DCI format indicates that a first switching pattern indicated by one of the one or more first configuration information is activated; and
applying the first switching pattern after a first time based on receiving the first DCI format,
wherein in a first time unit after the first time, the UE receives and/or transmits on the first cell, and
wherein in a second time unit after the first time, the UE receives and/or transmits on the second cell.

5. The method of claim 1, further comprising:
receiving a second downlink control information (DCI) format indicating that a second switching pattern indicated by one of the one or more first configuration information is deactivated.

6. The method of claim 5, further comprising:
receiving and/or transmitting on the first cell after a second time based on receiving the second DCI format.

7. The method of claim 5, further comprising:
receiving first indication information indicating that the UE receives and/or transmits only on the second cell after the second switching pattern is deactivated; and
receiving and/or transmitting only on the second cell after a second time based on receiving the second DCI format.

8. The method of claim 1, further comprising:
receiving a third downlink control information (DCI) format indicating receiving and/or transmitting on the first cell in the second time unit; and
receiving and/or transmitting on the first cell in the second time unit based on receiving the third DCI format.

9. The method of claim 1, further comprising:
receiving a fourth downlink control information (DCI) format indicating receiving and/or transmitting on the second cell in the first time unit; and
receiving and/or transmitting on the second cell in the first time unit based on receiving the fourth DCI format.

10. The method of claim 1, further comprising:
receiving second configuration information indicating a switching pattern among the first cell, the second cell, and a gap period in a special time unit among the plurality of time units; and
receiving and/or transmitting on the first cell and the second cell in a time division multiplexing (TDM) manner based on the switching pattern in the special time unit,
wherein the special time unit is a time unit including time resources for the first cell, time resources for the second cell, and time resources for the gap period.

11. A user equipment (UE) in a wireless communication system, comprising:
a transceiver configured to transmit and receive signals;
memory, comprising one or more storage media, storing instructions; and
a controller including one or more processors coupled to the transceiver and the memory,
wherein the instructions, when executed by the one or more processors individually or collectively, cause the UE to:
receive one or more first configuration information, wherein each of the one or more first configuration information indicates a switching pattern over a plurality of time units including a first time unit and a second time unit;
receive and/or transmit on a first cell in the first time unit; and
receive and/or transmit on a second cell in the second time unit.

12. The UE of claim 11, wherein the first configuration information includes a bitmap,
wherein a length of the bitmap corresponds to a total number of the plurality of time units,
wherein a first bit in the bitmap corresponding to the first time unit has a first value, and
wherein a second bit in the bitmap corresponding to the second time unit has a second value that is different from the first value.

13. The UE of claim 11, wherein the instructions, when executed by the one or more processors individually or collectively, cause the UE to:
transmit first UE capability information including a switching period between the first cell and the second cell; and
control not to receive and/or transmit during the switching period.

14. The UE of claim 11, wherein the instructions, when executed by the one or more processors individually or collectively, cause the UE to:
receive a first downlink control information (DCI) format, wherein the first DCI format indicates that a first switching pattern indicated by one of the one or more first configuration information is activated; and
apply the first switching pattern after a first time based on receiving the first DCI format,
wherein in a first time unit after the first time, the UE receives and/or transmits on the first cell, and
wherein in a second time unit after the first time, the UE receives and/or transmits on the second cell.

15. The UE of claim 11, wherein the instructions, when executed by the one or more processors individually or collectively, cause the UE to:
receive a second downlink control information (DCI) format indicating that a second switching pattern indicated by one of the one or more first configuration information is deactivated; and
receive and/or transmitting on the first cell after a second time based on receiving the second DCI format.

16. The UE of claim 15, wherein the instructions, when executed by the one or more processors individually or collectively, cause the UE to:
receive first indication information indicating that the UE receives and/or transmits only on the second cell after the second switching pattern is deactivated; and
receive and/or transmitting only on the second cell after a second time based on receiving the second DCI format.

17. The UE of claim 11, wherein the instructions, when executed by the one or more processors individually or collectively, cause the UE to:
receive a third downlink control information (DCI) format indicating receiving and/or transmitting on the first cell in the second time unit; and
receive and/or transmitting on the first cell in the second time unit based on receiving the third DCI format.

18. The UE of claim 11, wherein the instructions, when executed by the one or more processors individually or collectively, cause the UE to:
receive a fourth downlink control information (DCI) format indicating receiving and/or transmitting on the second cell in the first time unit; and
receive and/or transmitting on the second cell in the first time unit based on receiving the fourth DCI format.

19. The UE of claim 11, wherein the instructions, when executed by the one or more processors individually or collectively, cause the UE to:
receive second configuration information indicating a switching pattern among the first cell, the second cell, and a gap period in a special time unit among the plurality of time units; and
receive and/or transmitting on the first cell and the second cell in a time division multiplexing (TDM) manner based on the switching pattern in the special time unit,
wherein the special time unit is a time unit including time resources for the first cell, time resources for the second cell, and time resources for the gap period.

20. One or more non-transitory computer-readable media storing one or more computer programs including computer-executable instructions that, when executed by one or more processors of a user equipment (UE) individually or collectively, cause the UE to perform operations, the operations comprising:
receiving, by the UE, one or more first configuration information, wherein each of the one or more first configuration information indicates a switching pattern over a plurality of time units including a first time unit and a second time unit;
receiving and/or transmitting on a first cell in the first time unit; and
receiving and/or transmitting on a second cell in the second time unit.
